(19) United States
(12) Patent Application Publication
(10) Pub. No.: US 2026/0330204 A1
(43) Pub. Date: Oct. 22, 2026

(54) APPARATUS FOR OPERATING A HARDWARE-BASED ARTIFICIAL NEURAL NETWORK, AND USE AND METHOD FOR TRAINING SAME

(71) Applicant: Fraunhofer-Gesellschaft zur Förderung der angewandten Forschung e.V., Munich (DE)

(72) Inventors: Heiko ZIMMERMANN, Sulzbach (DE); Guenter FUHR, Sulzbach (DE)

(21) Appl. No.: 19/113,812

(22) PCT Filed: Sep. 22, 2023
(86) PCT No.: PCT/EP2023/076236

§ 371 Date: Mar. 20, 2025

(30) Foreign Application Priority Data
Sep. 22, 2022 (EP) 22197087.4

(51) Int. Cl. G06N 3/063; G06N 3/067; G06N 10/40

(52) U.S. Cl. CPC G06N 3/063; G06N 3/0675; G06N 10/40

(57) ABSTRACT

The invention relates to an apparatus for operating a hardware-based artificial neural network, said apparatus comprising at least one hardware-based artificial neural network (11, 24, 32, 41, 51, 71, 81, 101, 111, 121, 131, 171, 221) having a plurality of electrically interconnected network nodes, each network node comprising at least one electronic component, characterised in that the hardware-based artificial neural network has in particular an immutable hardware structure, the apparatus comprising at least one interference device (12, 22, 35, 42, 52a, 52b, 72, 82, 102, 112, 122, 132, 172, 222, 225) for coupling at least one interference signal in at least one region of the hardware-based artificial neural network and at least one coupling device (15, 23, 34, 43, 53a, 53b, 73, 83, 103, 113, 123, 133, 173), the coupling device being positioned between the interference device and the hardware-based artificial neural network and being designed to transmit the at least one interference signal from the interference device to the entirety of the at least one region, and/or the apparatus having at least one switching element, which can be actuated separately by means of at least one control signal, for dimming and/or switching a supply voltage for the at least one electronic component on and off. The invention provides an improved hardware-based artificial neural network which exhibits improved performance.

The invention relates to an apparatus for operating a hardware-based artificial neural network, its use and a method for training it.

Artificial intelligence can be used to detect patterns in technical applications, such as image recognition or monitoring machine parameters. Artificial neural networks that mimic the function of biological neurons can provide artificial intelligence. These artificial neural networks can be trained with training data using evolution-based methods, wherein the training adjusts the artificial neural networks so as to improve their ability to perform their tasks. The individual elements of the artificial neural network are re-associated during each training iteration.

In principle, such systems can be implemented as a hardware-based system, i.e. in which the hardware physically forms the network, or as a software-based system, in particular as a virtual network, which is simulated or emulated on a piece of hardware, for example a RAM memory and/or processor. In hardware-based systems, modifiable electronic elements are linked together to form an artificial neural network. Dozens of linked elements can be removed without the system losing its performance. In addition, hardware-based artificial neural networks may have elements that are unconnected to the rest of the network, i.e. unconnected and unused elements that cannot be removed without reducing or losing the performance of the hardware-based artificial neural network.

To reduce this effect, it is known e.g. from Cramer, B., Stöckel, D., Kreft, M., Wibral, M., Schemmel, J., Meier, K., & Priesemann, V. Control of criticality and computation in spiking neuromorphic networks with plasticity, Nature Communications, 11(1) (2020) 2853, to implement the highest possible signal-to-noise ratio between the linked elements, as this allows the number of sub-components to be brought into the thousands and the number of evolutionarily linkable connections into the tens of thousands.

Compared to software-based artificial neural networks, hardware-based artificial neural networks currently have a much more limited number of elements and connections, lower trainability, and lower complexity and flexibility.

Known artificial neural networks are specialized to individual tasks after their training. Furthermore, software-based artificial neural networks in particular are able to be manipulated from outside, as they are formed from program code and/or the simulating or emulating hardware is usually connected to the Internet. Further, therefore, output data of artificial neural networks is liable to be read by unauthorized persons.

There is therefore a need for broadly applicable, autonomous, protected and universally applicable artificial neural networks.

The object of the invention is therefore to provide an improved hardware-based artificial neural network in which the aforementioned disadvantages are eliminated.

The object is achieved by the features of the independent claims. Advantageous refinements are the subject matter of the dependent claims and the following description.

According to a first aspect, the invention relates to an apparatus for operating a hardware-based artificial neural network, comprising at least one hardware-based artificial neural network having a plurality of electrically interconnected network nodes, each network node comprising at least one electronic component, wherein according to the invention the hardware-based artificial neural network has in particular an invariant hardware structure, the apparatus comprising at least one interference device for injecting at least one interference signal into at least one region of the hardware-based artificial neural network and at least one coupling device, the coupling device being positioned between the interference device and the hardware-based artificial neural network and being designed to transmit the at least one interference signal from the interference device to the entirety of the at least one region, and/or the apparatus having at least one switching element, which can be actuated separately by means of at least one control signal, for dimming and/or switching a supply voltage for the at least one electronic component on and off.

A hardware-based artificial neural network is understood to include both biologically based neural networks, in which the nodes usually have comparable properties (weight, transmission function, etc.) and are arranged in layers, as well as electronic circuits in which the nodes of the network have different digital and/or analog circuit elements or components, in contrast to biologically based neural networks. These may also not be in the form of layers as in biologically based networks, but instead stochastically connected as an electronic circuit, so that in some of the circuit elements, for example, terminals provided as outputs can be used as inputs and vice versa. From the point of view of current electronics, this can result in “dumb” overall circuits, which obtain their “intelligence” through training. Hardware-based artificial neural networks can therefore also be referred to as trainable electronic networks. The circuit elements can also form the nodes of the corresponding network. The hardware-based artificial neural network can also be referred to as a physical neural network.

Unlike a software-based artificial neural network, where the output of each node in a layer of the network is determined sequentially, the output of the nodes of a hardware-based artificial neural network is obtained simultaneously for all nodes in a layer. This means that in software-based artificial neural networks, the number of nodes affects the time required to calculate the output of the artificial neural network. In hardware-based artificial neural networks, however, the number of nodes in a layer does not make any difference to the time it takes to determine the output. Only the number of layers determines the time taken to determine the output data.

An electronic component is understood to mean both a separately manufactured and/or usable component and a component that is manufactured and used simultaneously with other components, such as in the exposure of a silicon wafer, for example, as part of the manufacture of a semiconductor chip.

The invention provides an apparatus for operating a hardware-based artificial neural network in which an interference signal is injected into at least one region of the hardware-based artificial neural network. The interference signal is injected into the entire region, i.e. the interference signal is present in the entire region, or the region corresponds to the regions of the hardware-based artificial neural network covered by the interference signal. The at least one region can be smaller than the overall hardware-based artificial neural network. Furthermore, the apparatus has an interference device, which can inject an interference signal into a hardware-based artificial neural network. To inject the interference signal, a coupling device is provided between the interference device and the hardware-based artificial neural network. In one example, the coupling device may comprise simply an air-filled space between the interference device and the hardware-based artificial neural network. The interference signal emitted by the interference device is passed through the coupling device to the at least one region and injected there. injecting the interference signal causes an increase in the noise in the at least one region, so that the signal-to-noise ratio is reduced during the transmission of signals between the elements, e.g. nodes, of the hardware-based artificial neural network. Contrary to all efforts made in the implementation of electronic circuits, instead of an increase in the signal-to-noise ratio in the at least one region of the hardware-based artificial neural network, a spatial and/or temporal and/or partial reduction of the signal-to-noise ratio is thus counterintuitively carried out. This reduction is limited to at least one region in which the interference signal is injected, i.e. it is limited to some electronic components of the hardware-based artificial neural network circuitry. The signal-to-noise ratio (S/N) is defined by: S/N=10*log (useful power/noise), expressed in decibels (dB), or S/N=20*log (useful signal voltage/noise signal voltage). Readily transmissible signals have an S/N of greater than 15 dB, and an S/N of less than 10 dB is considered to be highly noisy. If the useful signal power is equal to the noise signal power, the signal is no longer identifiable at the receiver. Alternatively or additionally, the apparatus has at least one switching element which can dim and/or switch on and off a supply voltage for the electronic components, i.e. inter alia for the nodes or parts of the nodes of the hardware-based artificial neural network. The at least one switching element can be arranged in the at least one region and can be switched by the interference signal, which can then be referred to as a control signal. A switching element can therefore be controlled via an interference signal formed as a control signal. If multiple switching elements are present, each switching element can be controlled separately by control signals. The electronic assemblies can thus be dimmed, or switched on or off, with the supply voltage. Each switching element can actuate a separate electronic module. The control signals for the switching elements can form a control signal pattern over the surface of the hardware-based artificial neural network. The hardware-based artificial neural network can be trained by adjusting the control signal pattern. Using the invention, the hardware-based artificial neural network can thus be trained by modifying the interference signals and/or the control signals. It is no longer necessary to change the connections between the nodes of the hardware-based artificial neural network or the nodes themselves. Therefore, the hardware-based artificial neural network can have an invariant hardware structure. An invariant hardware structure is understood to mean, for example, that the hardware structure has no means of physically separating tracks between network nodes, or that the network nodes have no means of changing how they function. In this example, changes in the operating mode of the network nodes or in the electrical connections between the network nodes of the hardware structure can only be effected by means of the interference signals and the control signals for the control voltage. The interference signals or the control signals are used to modify the links between nodes or even the functioning of the nodes. The modification of the interference signals and the control signals thus replaces the adjustment or modification of the links between the nodes of the artificial hardware-based neural network. This eliminates the need to provide a hardware-based network having links that can be modified. A modification can be produced by changing the interference signals or by changing the supply voltage of the individual electronic components, so that the training of the artificial hardware-based neural network is transferred onto the modification of the control signals or the signals. This provides a highly flexible hardware-based network that can be trained to perform a variety of tasks. A separate control signal or interference signal for the electronic component can be determined for each task. The task for the hardware-based artificial neural network can thus be set by introducing a corresponding control signal or interference signal into an electronic component. This allows a single hardware-based artificial neural network to perform a wide range of tasks, such as firstly recognizing images and then recognizing audio data. This provides a broadly applicable, autonomous, protected and universally applicable artificial neural network.

According to one example, the hardware-based artificial neural network in the at least one region can have at least one component, which is designed to reduce the signal-to-noise ratio upon receipt of the at least one interference signal, wherein the interference device preferably generates an optical, acoustic, capacitive, electromagnetic, quantum-mechanical, resistive, thermal and/or ionizing interference signal and/or the switching element is preferably designed to receive an optical, acoustic, capacitive, electromagnetic, quantum-mechanical, resistive, thermal and/or ionizing control signal.

The signal-to-noise ratio is reduced by increasing the noise in the component. For this purpose, the component may be designed to be sensitive to the interference signal. For example, if an optical interference signal is used, the noise in the component during transmission of electrical signals in the component can be increased. The component may be arranged, for example, in an electrical connection between two network nodes or within one network node. The switching element can also be controlled by the control signal. The control signal can control the switching element in such a way that the supply voltage is dimmed and/or switched on or off.

According to a further example, the interference device can have a plurality of individually actuatable interference elements for injecting an interference signal into the hardware-based neural network, wherein the interference elements preferably inject an interference signal into different regions of the hardware-based artificial neural network.

Thus, multiple regions of the hardware-based artificial neural network can be influenced by interference signals, the regions preferably covering the entire hardware-based artificial neural network. Since the interference elements can be controlled independently of each other, each region in the hardware-based artificial neural network can be individually subjected to its own interference signal. The regions may overlap and/or be separate from each other.

Furthermore, the plurality of the interference elements can be arranged to be distributed over a layer, for example, preferably in the form of an array, wherein the coupling device comprises a medium having a plurality of coupling elements for transmitting the at least one interference signal into the at least one region, the coupling elements being distributed in the layer like the interference elements.

Thus, the interference elements can be used to generate an interference signal pattern, which is accordingly transmitted via the coupling device with the coupling elements to the hardware-based artificial neural network. Since the distribution of the interference elements in the layer is known, specific regions in the hardware-based artificial neural network can be targeted with interference signals. In particular, the distribution of the interference elements in the layer may be designed in such a way that the interference elements are arranged analogously to the components of the neural network. This allows specific interference signals to be injected into individual components.

Further, at least some of the plurality of interference elements may be designed as a resistance heater, a Peltier element, light-emitting diode, electromagnetic radiator and/or transmitter, and/or a piezo-component.

In a further example, the at least one region can have an extent corresponding to the extent of the hardware-based artificial neural network or is designed to be smaller than the extent of the hardware-based artificial neural network.

If the at least one region has the same extent as the hardware-based artificial neural network, the interference device or the coupling device can be formed homogeneously in order to apply an interference signal homogeneously to the entire hardware-based artificial neural network. A finer degree of structuring allows the interference signals to be injected into different regions in a component, for example, only to a signal input or a signal output of a circuit element of the hardware-based artificial neural network. For example, if the extent of the at least one region is equal to the extent of a component of the hardware-based artificial neural network and each component is assigned one region, an independent interference signal can be injected into each component of the neural network.

The plurality of coupling elements can thus have a structure that is the same as the structure of the plurality of interference elements. Furthermore, the structure of the coupling elements can also correspond to the structure of the hardware-based artificial neural network. However, this does not exclude the possibility that the structuring of the coupling elements might be finer or coarser than that of the interference elements or of the hardware-based artificial neural network.

According to another example, the apparatus may comprise at least one semiconductor chip, wherein the semiconductor chip comprises the hardware-based artificial neural network, the hardware-based artificial neural network being preferably formed in an integrated circuit, more preferably in a field programmable gate array (FPGA) or in an application-specific integrated circuit.

The neural network may be designed as a circuit on the semiconductor chip, wherein the nodes of the neural network can be formed as components of the circuit. In the example in which the elements of the neural network are designed as components of a Field Programmable Gate Array, the Field Programmable Gate Array may be configured such that the circuit structure of the elements of the Field Programmable Gate Array forms a neural network. In principle, a hardware-based artificial neural network which is also implemented in a Field Programmable Gate Array can be trained further. In contrast, a hardware-based artificial neural network is hard-wired on an application-specific integrated circuit and can be optimized in other ways beforehand. However, with the invention, training of the hardware-based artificial neural network is no longer required per se. This means that, for example, with any integrated circuit into which interference signals can be injected and/or the supply voltage of the individual parts of the circuits can be changed, the artificial hardware-based neural network can be trained by modifying the interference signals or control signals. Even when using a field programmable array, the array can be trained by modifying the input control signals or interference signals without needing to reprogram the array.

It is also conceivable that the apparatus can comprise a shielding device for shielding external interference signals which are of the same type as the at least one interference signal, wherein the shielding device surrounds the hardware-based artificial neural network, the coupling device and the interference device.

The shielding device may be designed, for example, as an enclosure which forms an outer shell of the apparatus. The interference device, the coupling device and the hardware-based artificial neural network are therefore surrounded by the shielding device. The shielding device can shield external interference signals, which may change the signal-to-noise ratio in an uncontrolled and non-reproducible manner. Thus, the interference signals of the interference device will almost exclusively cause the change in the signal-to-noise ratio in the regions of the neural network.

According to a further example, it is conceivable for the apparatus to further comprise at least one memory for storing the at least one interference signal used by the at least one interference device and/or the at least one control signal, at least one control unit for controlling the at least one interference device and/or the at least one switching element, and/or at least one output unit for outputting an, in particular further processed, output signal of the hardware-based artificial neural network.

The memory can be used to store interference signals or control signals during the training and after the training. Thus, for example, during a training process, all interference signals or control signals for an electronic component which were used during the training can be stored in the memory in order to avoid repetitions of training runs with identical parameters. After the training, the optimized control signal or control signal for the electronic component can also be stored in the memory. If multiple electronic components are present, the corresponding control signal or interference signals for each electronic component can be stored in the memory. A plurality of control signals or interference signals can be referred to as a signal pattern or signal pattern pair. The signal patterns or signal pattern pairs can be read from the memory if required. The memory may be designed to store a plurality of different signal patterns or signal pattern pairs. Each signal pattern or signal pattern pair may have been trained for a separate task. Then, for example, the type of task for each signal pattern or signal pattern pair can also be stored in the memory. For example, one signal pattern or signal pattern pair may have been trained for determining categories of image elements and another signal pattern or signal pattern pair, for example, for recognizing speech patterns.

It is also conceivable, for example, to design the interference device as a control device for providing at least one control signal for at least one switching element.

The control device can then, for example, read out from the memory the control signals that are currently to be used in order then to use them. For this purpose, the control device may, for example, receive a value that determines the task to be performed by the network. Based on this value the corresponding control signal can then be read, or control signal must have been read, from the memory that the control device must transmit to the switching element or switching elements so that the artificial hardware-based neural network can carry out the task.

According to one example, a plurality of apparatuses described above may be combined in an arrangement of a plurality of apparatuses according to the preceding description, wherein the hardware-based artificial neural networks of each apparatus are electrically connected to one another in series and/or parallel, wherein the interference devices of at least one first apparatus of the plurality of apparatuses and of a second apparatus of the plurality of apparatuses are preferably designed as a common interference device, an output layer of the hardware-based artificial neural network of a third apparatus of the plurality of apparatuses being preferably also designed to control the interference device of a fourth apparatus of the plurality of apparatuses.

Advantages and effects as well as refinements of the arrangement arise from the advantages and effects as well as refinements of the above-described apparatus. In this respect, for the avoidance of repetition, reference is therefore made to the preceding description.

The arrangement comprises at least two apparatuses according to the preceding description. In the arrangement, the output layer of a hardware-based artificial neural network of a first apparatus is electrically connected, inter alia, to an input of an interference device of a second apparatus or plurality of other apparatuses. The first apparatus can then control the interference device of the second apparatus or influence its function. In this way, each apparatus can be coupled to the interference devices of other apparatuses of the arrangement via an electrical connection of their neural networks.

According to a further example, a system comprising a plurality of arrangements according to the preceding description can be provided, wherein a first arrangement of the plurality of arrangements is designed to control at least one interference device in a second arrangement of the plurality of arrangements.

Advantages and effects as well as refinements of the system arise from the advantages and effects as well as the refinements of the above-described apparatus and the arrangement. In this respect, for the avoidance of repetition, reference is therefore made to the preceding description.

The first arrangement may form, for example, a base layer, the apparatuses of which emit an output signal which is processed by the apparatuses of the second arrangement, for example after further processing, as an input signal. In this case, at least one interference device of an apparatus of the second arrangement may be coupled to the output layer of at least one apparatus of the first arrangement. This can be referred to as forward coupling. It is further conceivable that at least one interference device of an apparatus of the first arrangement can be coupled to the output layer of at least one apparatus of the second arrangement. This can be referred to as backward coupling.

Furthermore, multiple systems can be regarded as sub-systems and be combined in a complex system, wherein the sub-systems are coupled to each other in the manner described above. In this way, a more complex system with further increased performance can be formed. A complex system such as this, for example, can (optically and acoustically) process signals of various kinds, with one sub-system processing the optical signals and another sub-system processing the acoustic signals.

In a second aspect, the invention relates to a method for training an artificial neural network in an apparatus according to the preceding description, the method comprising at least the following steps: defining target output data during the processing of supplied training data; feeding the training data into the hardware-based artificial neural network and injecting at least one interference signal into the at least one region of the hardware-based artificial neural network by means of the at least one interference device; obtaining output data from the hardware-based artificial neural network; determining whether at least one deviation exists between the output data and the target output data, said deviation being located outside a predetermined tolerance range; if the deviation is within the tolerance range: terminating the method; and if the deviation is located outside the predetermined tolerance range: modifying the hardware-based artificial neural network and preferably modifying the at least one interference signal; or modifying the at least one interference signal and/or modifying the at least one control signal; and repeating the above steps, in particular the steps of terminating the method and modifying the at least one interference signal and/or modifying the at least one control signal.

Advantages and effects as well as refinements of the method arise from the advantages and effects as well as refinements of the above-described apparatus. In this respect, for the avoidance of repetition, reference is therefore made to the preceding description.

In a first alternative, the method is used to train a hardware-based artificial neural network in a state that is perturbed by the interference device. The training of the neural network thus takes place with an interference of the signal transmission in the at least one region in which an interference signal is injected. In addition to the changes made to the hardware-based artificial neural network, changes to the at least one injected interference signal are also made during each training run. For this purpose, at least one parameter of the at least one interference signal, e.g. an intensity, a frequency, a duration, etc., can be changed. Changing the at least one parameter will also change the at least one interference signal. With the method, an interference device can thus be integrated into the training of a neural network. Thus, using the method a trained hardware-based artificial neural network can be provided, which has an increased performance over a neural network into which no interference signals are injected.

In a second alternative, with the training an interference signal or control signal is obtained, with which the unchanged hardware-based artificial neural network can solve a task posed by the training. The training is carried out by modifying the at least one interference signal and/or the at least one control signal only until the physically unchanged hardware-based artificial neural network successfully completes the training. A change in the physical connections, such as a physical disconnection or a physical reconnection between the network nodes or a physical change in the network nodes themselves, is not intended, but is not intended to be excluded either. In this alternative, therefore, only one interference signal and/or one control signal or one pattern of interference signals and/or control signals must be found, with which the hardware-based artificial neural network can successfully complete the training. In order to solve the task that was trained with the training process after the training, it is then necessary to simply apply the interference signal and/or control signal or the pattern of interference signals and/or control signals to the hardware-based artificial neural network. Thus, different tasks can also be carried out with a single hardware-based artificial neural network by carrying out correspondingly different training processes, with which different interference signals and/or control signals or patterns of interference signals and/or control signals can be determined.

According to one example, a signal-to-noise ratio of not greater than 15 dB, preferably not greater than 10 dB, further preferably not greater than 0 dB, can be generated in the at least one region by means of the injected interference signal.

Generally, it is the case that readily transmissible signals have a signal-to-noise ratio of more than 15 dB. A signal-to-noise ratio of less than 10 dB is considered to be highly noisy. If the useful signal power is equal to the noise signal power, the signal is no longer identifiable at the receiver. Nevertheless, a neural network can in principle also detect patterns in the noise at a signal-to-noise ratio of 0 dB or less, so that even with a signal that is no longer identifiable the output of the subsequent nodes of the neural network can still be influenced. The signal-to-noise ratio may also be less than 0 dB, preferably a minimum of −40 dB, more preferably −15 dB, further preferably −10 dB.

It is also conceivable, for example, that the hardware-based artificial neural network can remain unchanged in its structure.

In another example, it is conceivable that before the step of: defining target output data during the processing of supplied training data, the hardware-based artificial neural network can be trained, for example, without injecting interference signals.

This means that the neural network can be trained first, as is known from the prior art, in order to obtain an initial performance, e.g. a first accuracy value for the recognition of certain patterns. By means of the subsequent additional training with the injection of interference signals, the initial performance can be exceeded, wherein, for example, a second accuracy value for the detection of the specific patterns is achieved which is greater than the first accuracy value.

According to a further example, the last obtained interference signal and/or control signal can be stored, preferably together with a marker value for identifying the target output data used, wherein after the step of terminating (185) the method, the method is carried out at least once again using the same apparatus with modified target output data and training data.

Further, it is conceivable, for example, that the at least one interference device can have at least a plurality of individually actuatable interference elements, wherein each interference element is designed to inject an interference signal into the hardware-based neural network, wherein each interference element preferably injects an interference signal into a different region of the hardware-based artificial neural network, and the plurality of the actuatable interference elements can be actuated in such a way that the interference signals form a predefined interference signal pattern over the hardware-based artificial neural network, wherein a plurality of training iterations of the hardware-based artificial neural network are preferably carried out sequentially with different predefined interference signal patterns.

The predefined interference signal patterns can be used, for example, for an initial training iteration. In subsequent training runs, the interference signal pattern can be changed by changing the activity of individual or more than one of the individually actuatable interference elements, e.g. by reducing or increasing the signal strength. Because a predefined interference signal pattern can initially be injected, the training can be accelerated by using interference signal patterns already classified as suitable. Furthermore, the predefined interference signal pattern can also be used unchanged throughout the entire training.

Furthermore, it is conceivable, for example, that the interference signals and/or control signals can be test signals, wherein, when the test signals are used for feeding in predefined test data, predefined output data are provided only if no part of the hardware-based artificial neural network is damaged, has been replaced and/or been manipulated. The test signals can thus be used to check whether the hardware-based artificial neural network has been compromised, for example modified. If the hardware-based artificial neural network with the test data applied does not provide the predefined output data, it can be assumed that the hardware-based artificial neural network cannot fulfill the tasks assigned to it or will deliver false or manipulated results. This can increase confidence when using the hardware-based artificial neural networks.

According to a third aspect, the invention relates to the use of an apparatus according to the preceding description, wherein the apparatus is operated sequentially with at least two different signal sets, in particular for different tasks, wherein each signal set comprises at least one interference signal and/or control signal.

The different signal sets can be assigned to different tasks. For example, one signal set can enable the hardware-based artificial neural network to analyze images. A second signal set may be suitable, for example, for recognizing certain objects in the images. For example, another signal set may solve a completely different task, such as performing speech recognition.

Advantages and effects as well as refinements of the use of the apparatus arise from the advantages and effects as well as refinements of the above-described apparatus and the above-described method. In this respect, for the avoidance of repetition, reference is therefore made to the preceding description.

In a further example, a method for training artificial neural networks in an arrangement according to the preceding description can be provided, wherein the method for training an artificial neural network in an apparatus according to the preceding description is applied to the hardware-based artificial neural networks of the apparatuses, preferably after the apparatuses have been separately trained outside the arrangement by means of the method for training an artificial neural network in an apparatus according to the preceding description.

Advantages and effects as well as refinements of the method for training artificial neural networks in an arrangement result from the advantages and effects as well as refinements of the apparatus described above, the arrangement, and the additional previously described method. In this respect, for the avoidance of repetition, reference is therefore made to the preceding description.

Using the method for training artificial neural networks in an arrangement, all apparatuses of the arrangement can be matched to one another by the training to improve the performance of the arrangement. For this purpose, the apparatuses of the arrangement can be trained together right from the outset. Alternatively, the apparatuses can each be trained in isolation first, wherein no corresponding interference signal device is influenced by the output signals of another device. Only in a second training run, in which the apparatuses of the arrangement are matched to one another, can the interference devices be influenced by the output signals of other apparatuses of the arrangement.

In a further example, a method for training artificial neural networks in a system according to the preceding description can be provided, wherein the method for training an artificial neural network in an apparatus according to the preceding description is applied to the hardware-based artificial neural networks of the apparatuses, preferably after the arrangements have been trained separately outside the system by means of the method for training artificial neural networks in an arrangement according to the preceding description.

Advantages and effects as well as refinements of the method for training artificial neural networks in a system result from the advantages and effects as well as refinements of the apparatus, the arrangement, the system and the other previously described methods described above. In this respect, for the avoidance of repetition, reference is therefore made to the preceding description.

In the method for training artificial neural networks in a system, the different arrangements of the system are coordinated with each other. In this case, the arrangements can initially be trained individually without the apparatuses of other arrangements affecting the interference signal devices. Further, in this case, before training the arrangements, the devices of the arrangements can be trained separately from each other without any influence on the interference devices by other apparatuses. Alternatively, the arrangements and the apparatuses contained in them can be matched to one another in a single training of the system, wherein output signals of the arrangements can affect the interference devices of other arrangements.

In the following, the invention is described using an exemplary embodiment by reference to the accompanying drawing, in which:

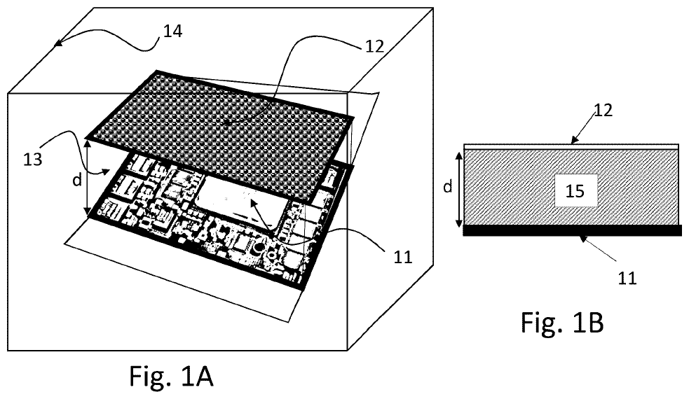

FIGS. 1A, B show a schematic illustration of the apparatus;

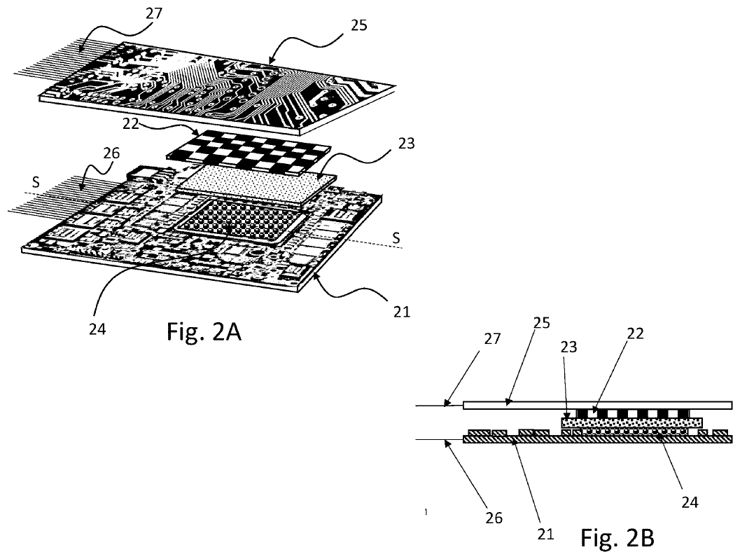

FIGS. 2A, B show a schematic representation of the apparatus according to FIG. 1A, b with further details;

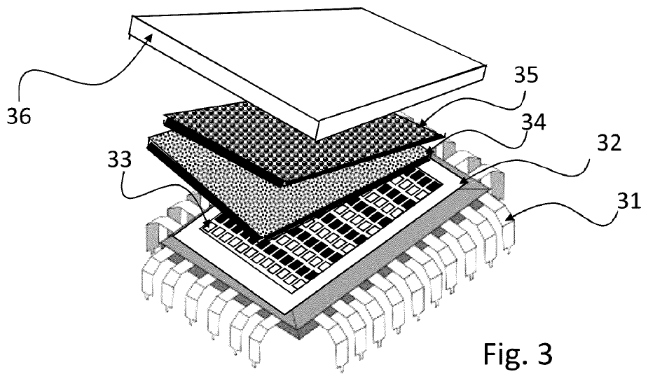

FIG. 3 shows a schematic representation of an example of the apparatus with an FPGA chip;

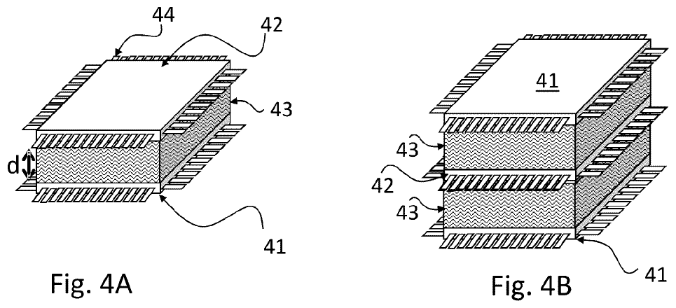

FIGS. 4A, B show a schematic representation of the example from FIG. 3 in further embodiments;

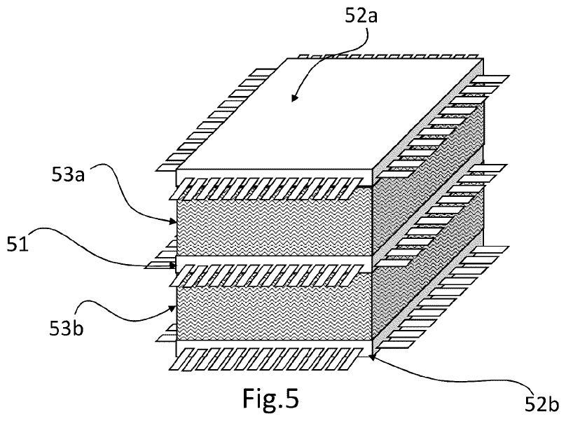

FIG. 5 shows a schematic representation of an example of the apparatus with two interference devices;

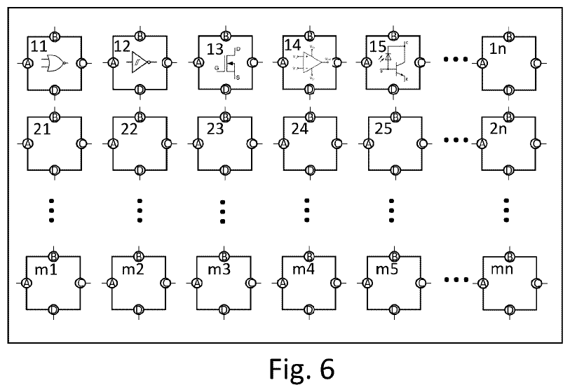

FIG. 6 shows a schematic representation of a basic structure of an FPGA chip;

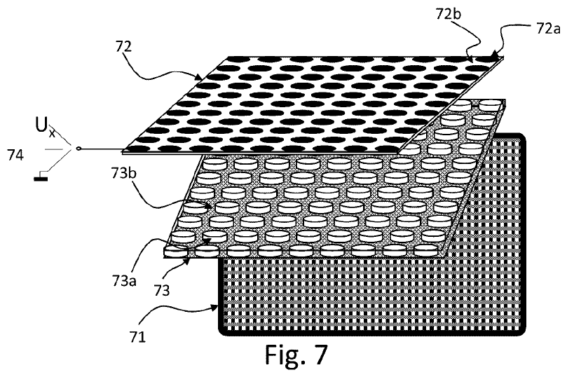

FIG. 7 shows a schematic representation of an example of the apparatus with capacitive interference elements;

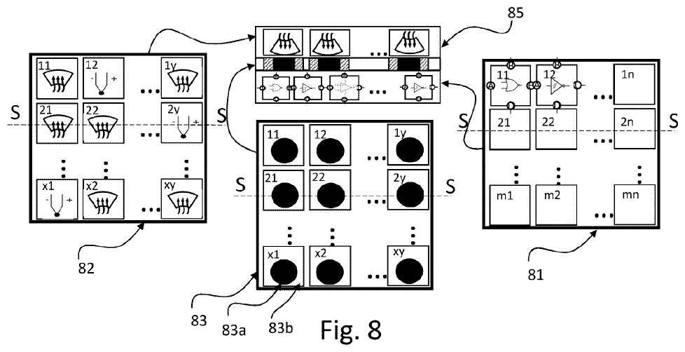

FIG. 8 shows a schematic representation of an example of the apparatus with heating and cooling interference elements;

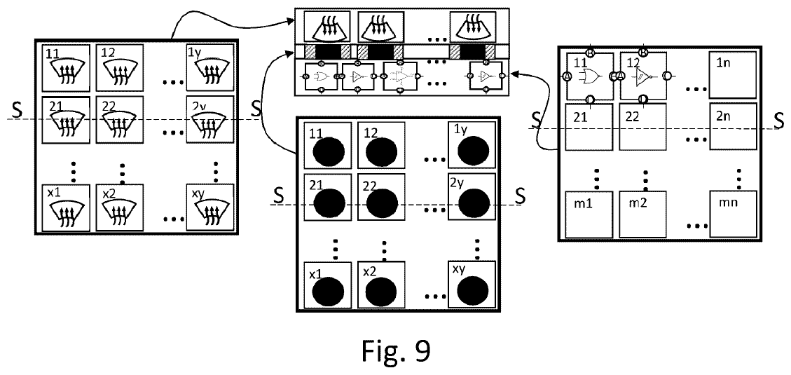

FIG. 9 shows a schematic representation of an example of the apparatus with heating interference elements;

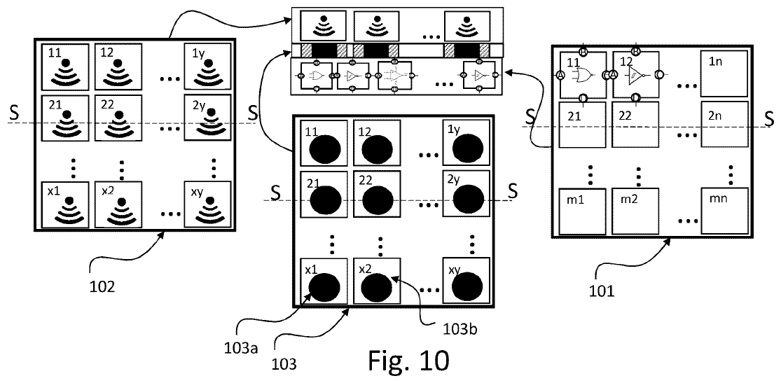

FIG. 10 shows a schematic representation of an example of the apparatus with sound-emitting interference elements;

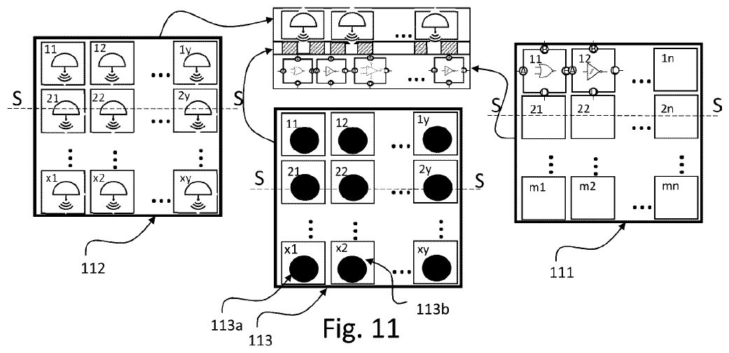

FIG. 11 shows a schematic representation of an example of the apparatus with interference elements that emit electromagnetic radiation;

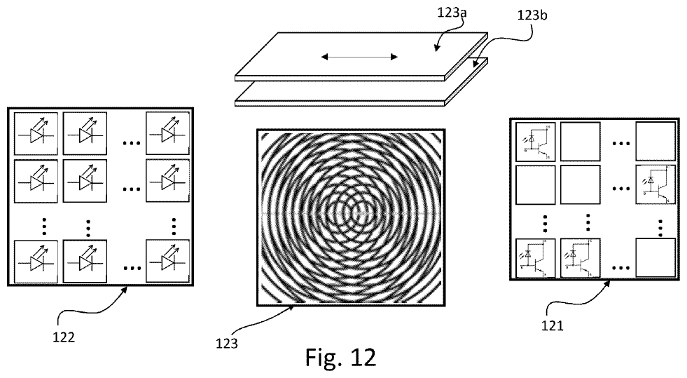

FIG. 12 shows a schematic representation of an example of the apparatus with a pattern-generating interference signal device;

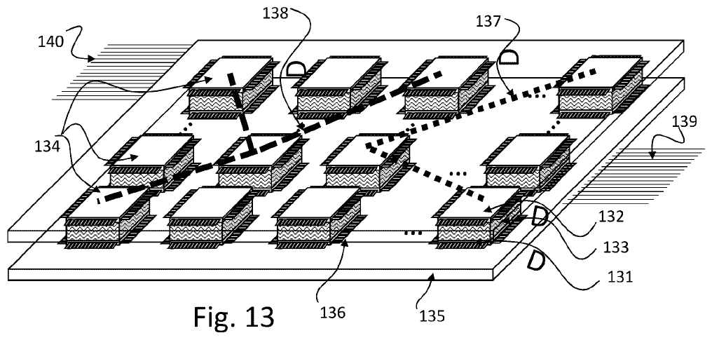

FIG. 13 shows a schematic representation of an arrangement with a plurality of apparatuses;

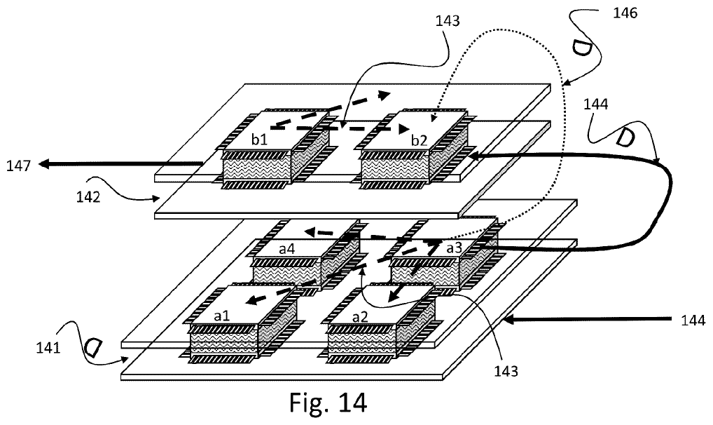

FIG. 14 shows a schematic representation of a system having a plurality of arrangements;

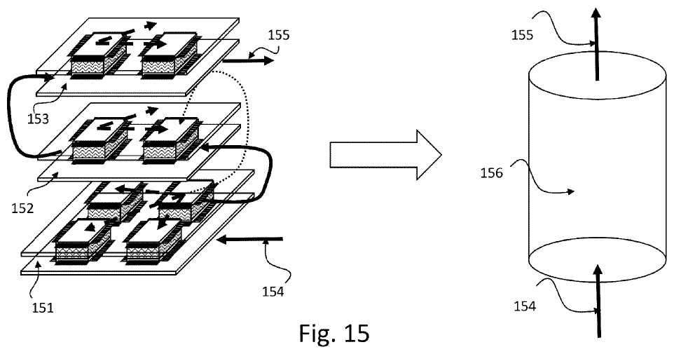

FIG. 15 shows a schematic representation of a further example of the system in an alternative mode of representation;

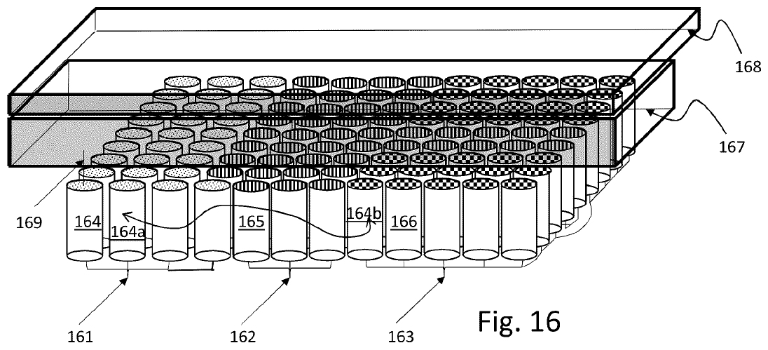

FIG. 16 shows a schematic representation of an example having a plurality of systems networked to each other via the interference devices;

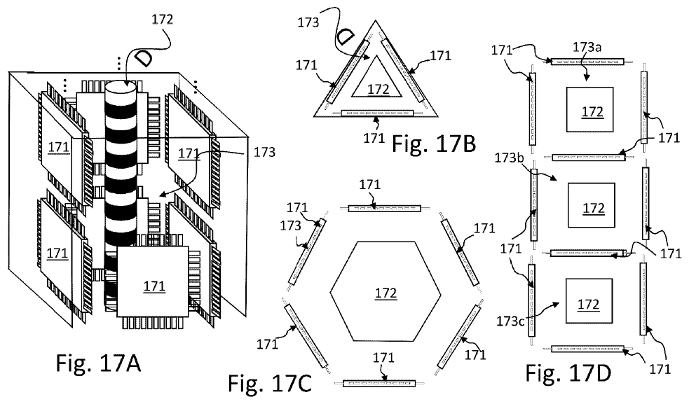

FIG. 17 shows a schematic representation of further examples of an arrangement of apparatuses;

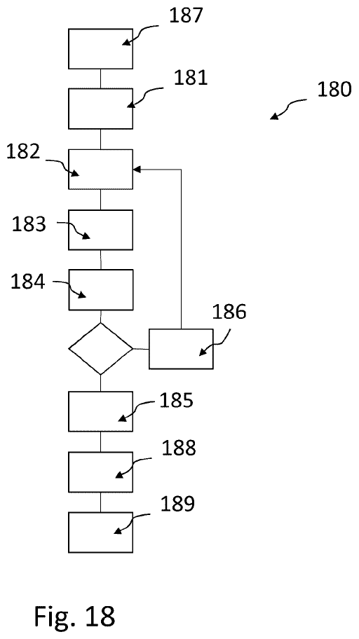

FIG. 18 shows a flowchart of the method for training artificial neural networks in a system;

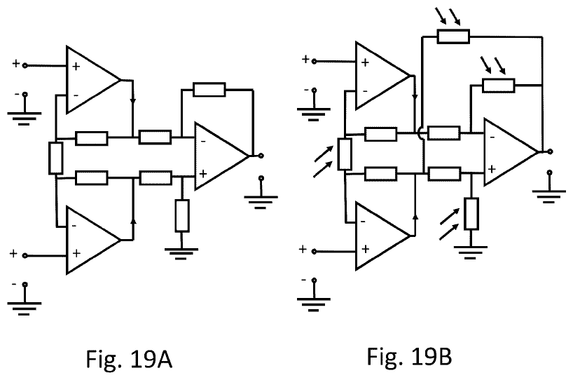

FIGS. 19A, B show a comparison between a conventional circuit and a circuit of a hardware-based artificial neural network adapted for the invention;

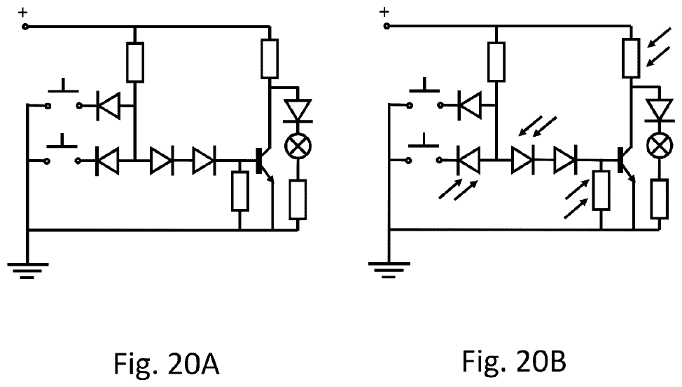

FIGS. 20A, B show a further comparison between a conventional circuit and a circuit of a hardware-based artificial neural network adapted for the invention;

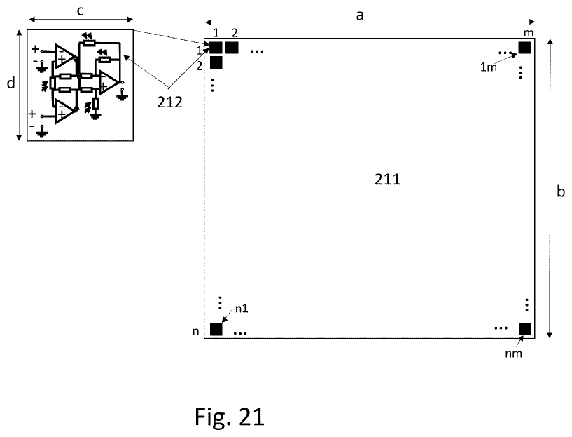

FIG. 21 shows an array-like structure of the semiconductor chip with the artificial hardware-based neural network;

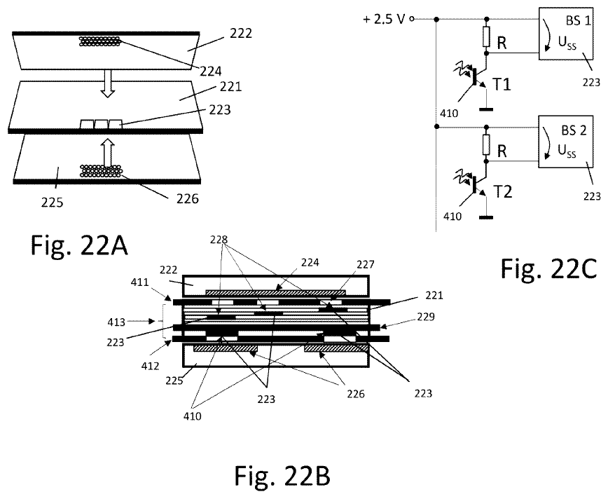

FIGS. 22A-C show an example of the apparatus as a semiconductor chip with interference device and switching elements for the supply voltage;

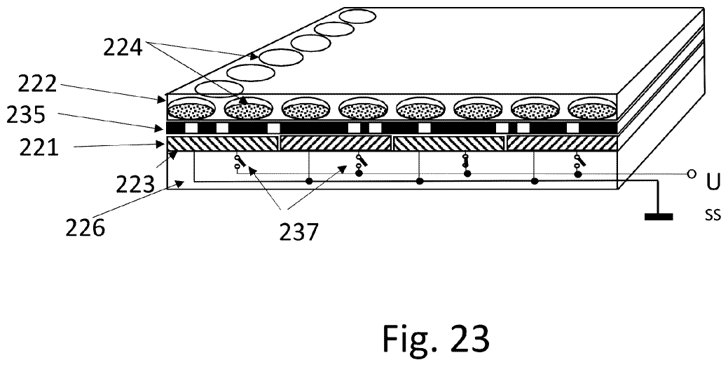

FIG. 23 shows an overview diagram showing a detail of the overall system of the hardware-based artificial neural network;

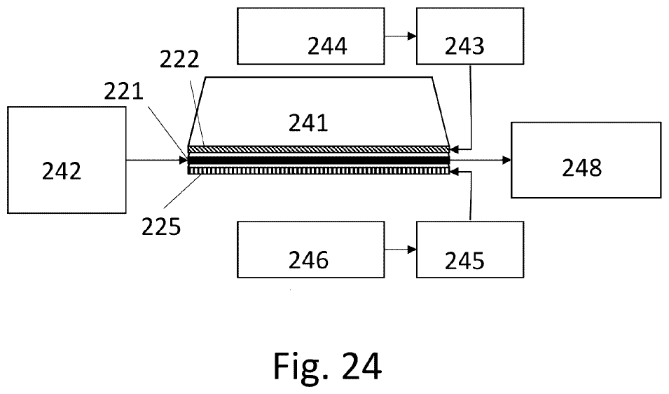

FIG. 24 shows an apparatus with additional peripherals;

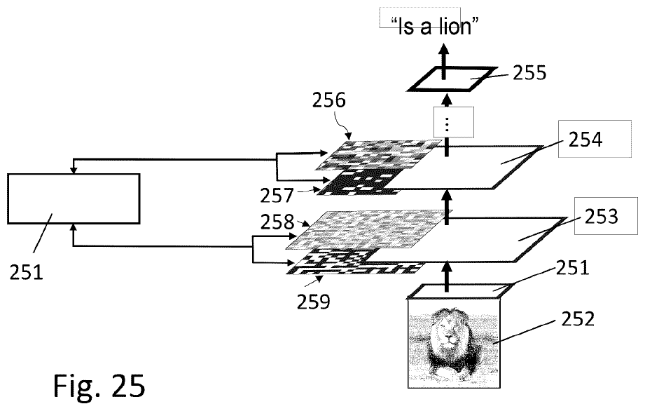

FIG. 25 shows layers of a hardware-based artificial neural network;

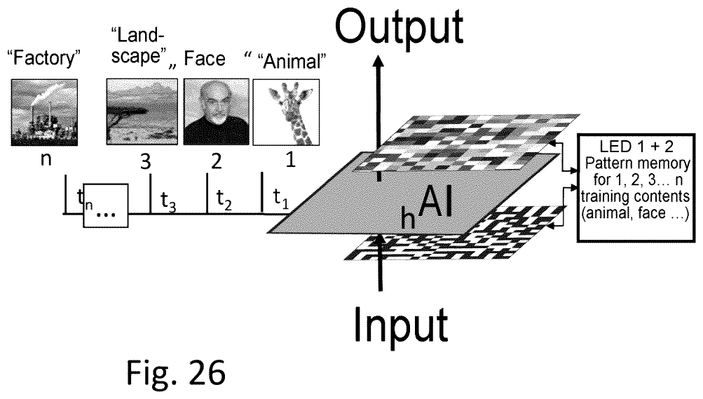

FIG. 26 shows a serial query of a hardware-based artificial neural network with different tasks;

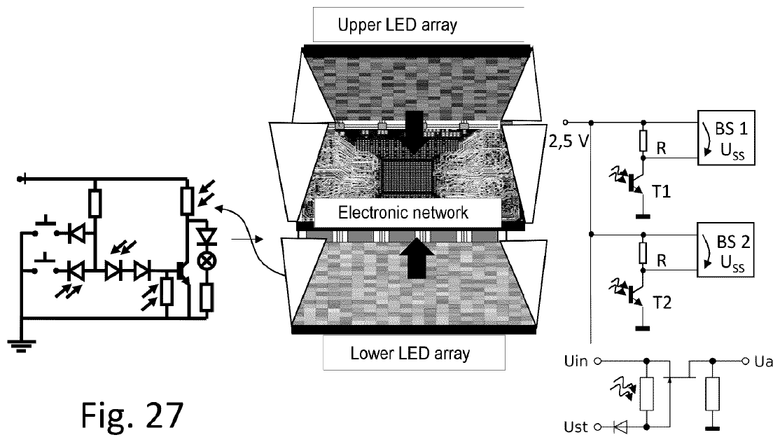

FIG. 27 shows an overall structure of the apparatus.

FIGS. 1A and 1B show the apparatuses, which are further expanded upon below: according to FIG. 1A in a spatial arrangement, according to FIG. 1B the essential components of the apparatus in a sectional view. This example shows an FPGA chip on a control circuit board 13, the individual components of which are linked via an evolutionary learning process, configured and trained to form a hardware-based artificial neural network 11. This layer of the hardware-based artificial neural network 11 largely corresponds to the industrially available chip-based systems and activation mechanisms described in the prior art.

The term “FPGA” is used in the following to represent all freely configurable electronic semiconductor chips. At a distance d, which is specified in more detail in the following examples, a further layer with an optionally array-like structure is arranged as an interference device 12, the elements of which, shown here as small spheres, can be switched on/off or adjusted in a controlled manner as interference elements. The actuation elements are not shown here.

This layer of the interference device 12 can generate interference signals in patterns and is referred to as the “interference signal layer”. They or their elements can generate interference signals which, via the space which is part of a coupling device 15, are cross-coupled into the layer of the hardware-based artificial neural network 11 locally into at least one region of the hardware-based artificial neural network 11, the interference signal being injected into the entire region. The region therefore corresponds to the regions of the hardware-based artificial neural network 11 covered by the interference signal. The region can cover the entire network, meaning that the interference signal can be injected into the entire network. This can be carried out homogeneously. Furthermore, if, for example, multiple regions are provided, the extent of the regions can be assigned to a group of individual components of the FPGA, separate individual components or only to sub-regions of the individual components.

Suitable interference signal array components can be miniaturized heating or cooling elements, optical, acoustic, resistive, electromagnetic, capacitive, mechanical or even quantum-mechanical components. Anything that can be injected into an electronic circuit, as realized in the layer of the hardware-based artificial neural network 11, is applicable.

Via the coupling device 15, which is hereinafter also referred to as the “coupling space”, the signals generated in the interference device 12 can be cross-coupled into the layer of the hardware-based artificial neural network 11 as patterns. Corresponding to the elements of the layer of the interference device 12, the coupling device 15 can be a medium, which, for example, mediates a thermal, resistive, electromagnetic, capacitive, mechanical or even quantum-mechanical transmission of the signals. In the simplest case, it can be a homogeneous medium, e.g. gas, liquid or solid. As a rule, however, the medium may comprise a vertically and/or horizontally structured combination of different materials to achieve a local effect in the direction of the layer of the hardware-based artificial neural network 11 and adapted to their array structuring, meaning that the medium of the coupling device 15 can be adapted to suit the arrangement of the linkable elements of the FPGA chip, i.e. to the hardware-based artificial neural network. The distance d can also be varied, but will usually be chosen to be small in comparison to the surface area of the layer of the hardware-based artificial neural network 11, in order to be able to generate local effects in the hardware-based artificial neural network 11, in particular in the FPGA chip.

In contrast to conventional uses of semiconductor chips and semiconductor components, the components on board the layer of the hardware-based artificial neural network 11 may be partially and not completely shielded from external effects, so that injections are only possible from the layer of the interference device 12.

Therefore, due to the increased sensitivity of the components of the hardware-based artificial neural network 11 to external signals, an encapsulation of the apparatus can be provided as a shielding device 14 against precisely these interference signals.

In this basic arrangement of a hardware-based artificial neural network 11 according to the invention, the main component for the evolutionary learning process is the layer of the hardware-based artificial neural network 11. The layer of the interference device 12 forms a higher-level, but subordinate component, which makes this process in the layer of the hardware-based artificial neural network 11 more complex and can also be optimized via the or a second evolution algorithm and learning process. The overall unit from 11 to 15 can be understood and referred to as an intelligent hardware AI system and can be referred to as an AI basic unit.

The training process can be carried out in two variants. In a first alternative, the hardware-based artificial neural network 11 and the interference device 12 can be modified simultaneously in the evolutionary process. In a second alternative, only the hardware-based artificial neural network 11 might be trained first and, if this training shows positive results, the interference device 12 can be added. If the apparatus comprises more than one hardware-based artificial neural network 11 and more than one interference device 12, any combination may be subjected to separate and joint training according to the first or second alternative.

In contrast to prior art systems, by avoiding undefined interference effects, the defined separation of the interference signals by the interference device 12 and the coupling device, highly complex systems are realizable and controllable and the probability of achieving a positive training result increases.

FIGS. 2A and 2B illustrate an example which explains the spatial relationships. FIG. 2A shows a three-dimensional exploded drawing and FIG. 2B shows a section along the line S-S in FIG. 2A.

An FPGA chip 24, in which the hardware-based artificial neural network is implemented, may be arranged on a board 21, e.g. a multilayer PCB for actuating and configuring the FPGA via the terminals 26. Configuration can be carried out via digital computers. The FPGA 24 is not encapsulated in a shielded manner, but can instead be covered with the coupling medium 23 of the coupling device, followed by the interference device 22, which is shown here in the form of an array in a checkerboard pattern with individual interference elements for local generation of interference signals for the FPGA. The interference device 22 is in turn connected to a board 25 for actuating the interference elements via the terminals 27. In the simplest case, arbitrary patterns can be generated by switching the interference elements of the interference device on and off, which act locally on the FPGA chip 24 via the coupling medium 23.

With regard to the distance d from FIG. 1A, in this example it is small compared with the extent of the surface of the FPGA chip 24. Typically, the distance is between 0.1 mm and 5 mm, preferably 0.5 mm. The geometric relationships can be seen in the section S-S in FIG. 2B.

As an example, the array of the interference device 22 may consist of small heating elements or Peltier elements, which are coupled via a medium 23 with high thermal conductivity, e.g. via a metal or diamond layer. This layer can be structured as an array in columns with good and poor heat conduction to transfer a temperature pattern to the FPGA. This allows a variable, trainable and switchable interference signal pattern to be generated.

A first degree of structuring of the interference device, which is a measure of the structuring of the distribution of the interference elements, can be adapted to suit the structuring of the FPGA, the structuring of which can be specified in this example with a second degree of structuring, that is, selected to be geometrically similar. Then, in each region in which an interference signal is injected by the interference device into the hardware-based artificial neural network, implemented in the FPGA, a basic element of the FPGA is arranged. In other words, one basic element of the FPGA is then manipulated by each interference element.

However, this is not essential because the first degree of structuring can equally well be structured more finely as more coarsely than the second degree of structuring, with the ratio of the first degree of structuring to the second degree of structuring preferably having values in a range between 10:1 for the finer structuring and 0.1:1 for the coarser structuring.

The coupling medium 23 of the coupling device can have structuring, which is specified with a third degree of structuring. The third degree of structuring may also be finer or coarser than the second degree of structuring.

FIG. 3 shows a compact technical arrangement of the apparatus described in FIGS. 1A and 1B. In a semiconductor chip holder 31, e.g. a ceramic having a plurality of contact pads, an FPGA chip 32 with the linkable electronic basic components 33 may be arranged. In addition, the coupling medium 34 and the interference device 35 with an array of interference elements can be arranged directly thereon.

The entire chip can then be encapsulated 36 so as to be shielded against external influences. In the case of electromagnetic elements in the interference device, this can be e.g. a metal encapsulation, in the case of optical interference signals it can be a non-transparent coating.

This compact chip design allows the combination of such chips on one board to form complex structures or even stacks, as explained in the following examples. Chips of this kind can be used to assemble a plurality of AI basic units and combine them into layers and hierarchies.

FIGS. 4A and 4B schematically illustrate the exemplary combination of compact chip systems. FIG. 4A shows an apparatus as an AI basic unit according to FIG. 3, comprising the FPGA 41, the coupling medium 43 of the coupling device and the interference device 42 with the electrical contact pads 44. The thickness of the coupling medium can vary between 100 μm and 5 mm, preferably from 200 μm to 600 μm. Furthermore, the coupling medium may have a plurality of coupling elements, which can be structured or unstructured according to a third degree of structuring. In particular for using signal patterns, a structuring of the coupling medium is provided.

In FIG. 4B, two apparatuses are shown combined with each other. The combination of the two apparatuses has two FPGAs 41, which are connected to a common interference device 42 via two coupling media 43. The FPGAs are aligned head-to-head.

In an analogous manner, further combinations can be realized as horizontal or vertical stacks. The advantage of a common interference device for multiple FPGAs is the reduction of the actuation complexity.

Furthermore, interference signal patterns can be generated which are either fixed in advance or have been optimized by evolution-based methods during training with the FPGA. Such systems also offer the advantage that the upper and lower FPGA can also be subjected to different interference signal patterns in a temporally separated sequence or alternately, resulting in more complex training and more complex AI systems with low switching complexity.

FIG. 5 shows a further variant. In this example, an FPGA 51 is arranged between two coupling media 53a and 53b and two interference signal layers 52a and 52b. This results in multiple options for the injection of interference signals, in the context of growing but well-defined complexity of the apparatus.

For example, a symmetrical injection of identical interference signal patterns onto the center of the FPGA chip from above and below can be provided. Alternatively, for example, an asymmetrical injection of identical or different interference signal patterns into the FPGA chip can be provided. In another alternative, for example, a temporally separated injection from above and from below can take place. Furthermore, an alternating injection of asymmetrical interference signals from above and below can be provided, for example.

FIG. 6 schematically shows the basic principle and basic structure of FPGA chip arrays. Since the FPGAs are usually structured as an array, for reasons of intelligibility, the representation with rows 1 to m and columns 1 to n was chosen. Via four connections A, B, C, D in each case, electronic basic elements, the position of which can be identified with the indices 11, 12, [. . . ], m5, mn, can be connected to each other in a short-circuit-proof configuration to form a hardware-based artificial neural network. Even incorrect wiring connections, e.g. using the output of an element as an input, are also permitted in hardware-based artificial neural networks.

As shown by way of example with the basic elements at positions 11 to 15 in the top row of the array shown, the elements of the FPGA can be digital as well as analog circuits. The symbols used correspond to the electronic nomenclature. It is also possible to mix analog and digital devices. The electronic elements mn are not shielded against interference in the usual way, but may even have assemblies that react sensitively to optical, acoustic, thermal, electromagnetic and other signals generated by the interference device. The type of configuration and the evolutionary programs used for training are prior art and are therefore not explained in more detail here.

In FIG. 7, the three layers of the apparatus (hardware-based artificial neural network, coupling device and interference device) are shown with a capacitive interference.

The FPGA 71 in this example, as a hardware-based artificial neural network, has a second degree of structuring which is finer than the first and third degrees of structuring of the interference signal device 72 and the coupling device 73. The structuring of the FPGA, the interference device and the coupling device can be of the same or different type. Accordingly, it is then possible to not only manipulate a single basic element of the FPGA, but a group of basic elements simultaneously or only a sub-region of a basic element.

The interference device 72 may comprise, for example, small metal plates or metal pads 72a as interference elements, which are embedded in an electrically insulating medium 72b. Each pad 72a can be activated via a computer program in the same way as the operation of the FPGA. In the simplest example, three assignments of each pad are possible, as shown at 74: 1. Application of a positive or negative voltage Ux, 2. Open pad, i.e. no potential binding, wherein the pad searches for its potential in the chip environment itself, and 3.Connection to ground, so that arbitrary charge patterns can be generated in the array.

In the example shown, the coupling device 73 is structured in the same manner, so that under each metal pad a material having a high dielectric constant 73a, embedded in a medium having a low dielectric constant 73b, can be arranged as a coupling element. With the surface of the FPGA 71, the metal pads form local capacitors, via which displacement currents can be injected into each of the locally adjacent regions of the hardware-based artificial neural network.

In the evolutionary training process, the assignments of the interference elements 72a can be varied via an evolution algorithm, in a similar way to the training of the hardware-based artificial neural network. This means that at the outset a random assignment of input signals can be generated and applied for the interference device 72. The artificial neural network implemented in the FPGA can then receive an input signal. If this is interpreted correctly by the neural network at the output, nothing is changed in the configuration of the interference device 72 and the next training signal is applied to the FPGA. If the input signal is evaluated incorrectly, for example, the assignment of a few pads or interference elements is changed on a random basis, as is also the case with the switching connections in the FPGA. Both algorithms can, but do not have to, match. If this is repeated a few hundred to a few thousand times, which can be referred to as “generations” in the evolutionary algorithm, the desired success rate of the entire apparatus can be achieved.

FIG. 8 shows a 3-layer AI chip in which interference signals can be generated via an array of heating and/or Peltier elements 82, which in this example represent the interference elements. The temperature can be transferred from the interference elements to the local basic elements of the FPGA 81 via the coupling device 83. The basic elements arranged as an array at positions 11 to mn of the FPGA can either be produced as temperature-sensitive elements according to the standard semiconductor manufacturing methods, or are designed in such a way that they react in terms of signal behavior to small temperature differences, for example, a few degrees or fractions thereof.

The coupling device 83 in this example is also composed of two components: the highly thermally conductive, cylindrical regions 83a and the poorly thermally conductive regions 83b in between. The material 83a can be, for example, a metal such as copper or silver, or a diamond layer processed by semiconductor technology. The insulation material 83b can be a poorly thermally conductive plastic material, glass or even a ceramic material.

The interference device 82 in this example can have a plurality of heating and/or cooling elements, e.g. miniaturized resistance elements or Peltier elements, as interference elements. In this way, arbitrary temperature patterns can be transferred to the FPGA underneath. The temperature differences can be selected in wide ranges, e.g. in a range between −20 °C and 100 °C, but preferably in the degree range near to room temperature or below.

In the box 85, which is shown at the top center of FIG. 8, the structure of this AI basic unit is shown in the vertical section S-S. Here again, the array structure of the layers of the interference device, the coupling device and the neural network does not have to match, i.e. the number of interference elements and coupling elements can, but does not have to, correspond to the number of basic electronic elements.

The generated temperature patterns are typically static, meaning that they are constant for the working cycle of the neural network, which corresponds to a decision run. However, it is also possible to generate dynamic changes across multiple decision runs of the FPGA.

The training procedure is similar to the description in FIG. 7.

In FIG. 9, an apparatus is shown with an interference device which only has heating elements. Otherwise, this example is structured as described in FIGS. 7 and 8.

In FIG. 10, an interference device 102 is shown, which has miniaturized sound transmitters as interference elements, which emit sound signals of different frequencies, for example via vibration. The sound transmitters can be piezo-elements or piezo-crystals or small diaphragms which generate individually activated sound patterns.

In this example, the coupling device 103 can comprise sound-transmitting regions 103a, e.g. a mechanical solid-state coupling or miniature sonotrodes, and sound-damping intermediate spaces 103b, e.g. sound-absorbing materials, e.g. material with extremely small cavities.

The basic elements of the FPGA 101 can be designed in such a way that they can be perturbed to a certain extent via sound frequencies. The effect can be reinforced and designed to be more complex if the basic electronic elements of the FPGA have sound receiver components, for example. This can be the case for part or all of the basic elements of the FPGA. The advantage of the application of sound is its broad frequency range, which ranges from infrasound via the human hearing range to ultrasound. This allows not only sound patterns of one frequency, but also sound patterns of different frequencies to be generated.

This example graphically illustrates the extended range of possibilities associated with the introduction of interference devices and coupling devices into hardware-based artificial neural networks. In interconnected arrangements and systems, as explained in the following figures, each of these interference devices can be varied in intensity as a fixed sound pattern, shifted in frequency as a whole, modified in its frequency composition/spectrum, changed as a pattern, or operated in combinations of the above options.

If it is assumed that the entire system of hardware-based artificial neural network, interference device and coupling device has been optimized for a certain frequency pattern and achieves its highest success rate in this actuation pattern, a modification/detuning of the interference signals would lead to a worse result. In extreme cases, the neural network only functions in a certain intensity interval or frequency interval. This means that it is possible to use the interference signals alone to worsen or improve an apparatus if it has previously been operated in a suboptimal manner. This leads to the option of interconnecting many apparatuses in a hierarchical or even non-hierarchical manner in such a way that, via the success rate of a neural network, other hardware-based artificial neural networks connected to it can be influenced by their interference signals.

FIG. 11 shows an FPGA 111 comprising an artificial neural network of the type already described. In this example, the interference device 112 can have as interference elements miniaturized transmitters for high-frequency electromagnetic waves up to the microwave range, which can be designed, for example, in the manner of antennas or their signal can be transmitted to the FPGA via the coupling device 113 by means of a waveguide 113a as a coupling element.

Analogously, the interference device may have infrared or LED elements in the visible spectral range or in the UV range as interference elements. In addition, the injection can be carried out via optical fibers or small pinholes as coupling elements. A very wide range of possible operating and training types is also obtained for this apparatus, analogous to FIG. 10.

In FIG. 12, an alternative apparatus is shown with an interference device which can only generate interference signals in patterns. For this purpose, the coupling device 123 has two or more layers 123a, 123 b, on which patterns may be applied, for example, on each layer concentric rings, which are alternately transparent and non-transparent, wherein the centers of the concentric rings of the two layers are shifted relative to each other. This results in symmetrical or asymmetrical superposition patterns. The interference device 122 can then have a light-emitting diode array. In this case, the coupling device 123 is not an array as in the preceding examples. Instead, the superposition pattern can define the pattern formed by the interference signals in the neural network. The FPGA chip 121 can have e.g. light-sensitive components in its electronic basic elements.

FIG. 13 shows an arrangement of devices as an ensemble of AI basic units corresponding to FIGS. 3 to 5. On the control circuit board 135, FPGA chips 131 can be electrically contacted, wherein the interference devices 132 can be electrically contacted on the underside of the upside-down, transparently illustrated control circuit board 136. The coupling devices 133 are arranged in between them.

Via first actuations 139 of the control circuit board 135 for the FPGAs 131 and second actuations 140 of the control circuit board 136 for the interference devices 132, the AI basic units 134 can be trained as already described, separately and/or jointly. If each AI basic unit 134 has been trained on a different group of features, for example, a first on the recognition of cats, a second on dogs, a third on horses, etc., then the arrangement in FIG. 13 forms a more complex AI system with higher performance/intelligence than the AI basic units exhibit as individual devices.

The interference devices can also be partially electrically connected to each other, as shown schematically via the interrupted lines 137, 138. This results in a further option for the control and the evolutionary training of the entire arrangement.

These connections can be used to transmit signals between the interference devices 132, which change the performance of other AI basic units in a fixed manner, for example exclusively via the respective injection of interference signals with which the corresponding artificial neural networks in the FPGAs can be manipulated as already explained above. This can be carried out, for example, by increasing or reducing the intensity of the interference signal in the connected AI basic unit. This means that each AI basic unit can act in an improved or even optimal manner, e.g. the devices connected via the dashed connecting line 138, or else be detuned and thus degraded or switched off, e.g. the devices connected via the connecting line 137. For example, in the animal recognition example above if it is assumed that half of the AI basic units can recognize animals, and the other half art objects that look like animals, then such an interconnection can ensure that initially many of the AI basic units are controlled in the suboptimal range by the detuning of the respective interference devices and are driven e.g. at 80% of the maximum performance. When the devices are provided with an input signal, e.g. the image of a mule, the individual AI basic units classify this input signal with different results.

The devices that can recognize cats will output, for example, a 2% match of the mule with a cat, those that can recognize horses will output, for example, a 90% match, those that can recognize art objects may also respond e.g. in the detection range of a few percent up to 60% in the case of horse sculptures. The AI basic unit with the highest match rate, in this case the devices that can recognize horses, can then switch its interference device to optimal operation. Furthermore, previously detuned interference devices of the AI basic units connected to it can also be switched simultaneously to the optimal interference signal mode, e.g. one AI basic unit for detecting wild horses, one for detecting zebras and one for detecting hybrids of the horse family. At the same time, via connections to the devices that can recognize art objects it can suppress all except the one with the highest percentage of hits. This device with the highest percentage of hits for detecting art objects can activate further devices that can detect works of art via its connections, by an optimal adjustment of the interference devices.

Now, a new iteration of the mule image can be started until it is decided which object in the whole system the mule comes closest to and whether it is an animal or an object.

Such an arrangement has one training layer more than the AI basic units, namely that of the interconnection of the devices to one another, which can also be achieved via evolutionary optimization strategies.

With a plurality of, at least two, arrangements according to FIG. 13, hierarchically or otherwise organized complex systems can be constructed, as shown in FIG. 14. A base layer 141 is shown, comprising an arbitrary number of AI basic units, wherein for reasons of clarity FIG. 14 shows, for example, only four devices with the designation a1 to a4, which can be interconnected with one another for activation or suppression via electrical connections 143 between the associated interference devices. In this layer, the input signal 144 can be fed into all AI basic units a1 to a4, e.g. by connecting the inputs of the devices in parallel.

The AI basic unit with the highest recognition probability can be cross-coupled to the next higher layer 142. There, the input signal 144 can now also be applied to all AI basic units, wherein for reasons of clarity only two devices b1, b2 are shown in layer 142, which can also be partially or completely interconnected via electrical connections 143 between the interference devices. In this layer also, an AI basic unit with the highest recognition probability can be determined, which can then generate the output signal 147.

Typically, the number of AI basic units can be a maximum in the lowest layer and decrease toward higher layers. This is not essential, however. Expanded decision categories or new links can also be created with each layer. For example, patterns can be compared in the higher-level layers after the object has been recognized, and acoustic signals can be added in the next layer to reveal contradictions that would otherwise lead to a miscategorization. For example, if an object recognized as a cat neighs like a horse. Such a system can have larger AI basic units in higher layers than in a lower layer.

On the left of FIG. 15 a system with a hierarchical AI structure is shown, consisting of three layers 151, 152 and 153 with the input 154 and the output 155 analogous to FIG. 14. Such complex AI interconnections are grouped together in the following, as shown on the right of FIG. 15, as a cylinder 156 with the input 154 and the output 155, in order to be able to represent more complex structures.

FIG. 16 schematically shows an even more complex structure. It consists of a plurality of systems according to FIG. 15, which are shown as cylinders 164-166. They can be oriented in a layer in the same direction, wherein for reasons of clarity only the cylinder 164, by way of example, shows the respective input 161 oriented downwards and the respective output 169 oriented upwards.

The systems can be arranged in domains which are marked by a specific pattern on the top of the corresponding cylinders, with one pattern each marking the systems of a domain.

In FIG. 16, three domains are illustrated, which can be composed of three system types 164, 165, 166. As can be seen in system type 166, not all systems in a domain need to be directly adjacent. Individual systems can also be arranged in another domain as a solitary unit (not shown here). In this way, strong and weak interactions between the domains can be realized via the interference devices.

The systems in a domain can receive a common input signal. It is expedient to organize the domains in such a way that they each receive different or modified input signals, e.g. parts of the general input signal, which in FIG. 16 are designated with the reference signs 161, 162 and 163.

There may be reciprocal or directed connections between the systems, via which they can be stimulated or suppressed, or can also stimulate or suppress other systems. These connections can usually start from the top layer, i.e. the result layer, see FIG. 15. When input signals 161 to 163 are applied, the individual systems can already arrive at more complex responses with different recognition probability than without these connections.

Analogous to the operation of the individual systems according to FIGS. 14 and 15, the systems within the domain and beyond it can be strengthened and weakened. The connections to other domains, which can easily be very far apart, as illustrated for example by the connection arrow from system 164a to system 164b, allow larger system ensembles to be controlled in their activity via the interference devices. These ensembles of systems have a further training layer in addition to those already described above.

The system with the highest hit rate of a domain can be cross-coupled via a switching layer 167, which feeds the result into a projection layer 168 in which the results of the other domains with high hit rates and the input signal can be input and displayed for comparison.

This arrangement allows, for example, pandemonium-like structures to be implemented, such as are suspected to exist in the human brain. The systems correspond to the column structure of the cerebral cortex, the domains, for example, to the optical, acoustic, haptic, or olfactory cortex. Via the cross-connections between the systems and between the domains, association-like modes can be created and trained which ultimately represent nothing other than associations between phenomena that are not actually related to each other, for example, the implementation of an optical pattern in music, etc. As can be seen, with the underlying apparatuses, e.g. FGPAs with interference device, their interconnection and manipulation via the interference devices, the linking of apparatuses to form arrangements and their aggregation in systems, subsequently via the arrangement of the systems in layers and domains, an overall AI system can be created, which can be made universally intelligent via a plurality of evolutionary training cycles to be carried out sequentially and/or simultaneously. The more extensive the systems, the more complex the training structure can be made.

FIGS. 17A to 17D show alternative apparatuses. In the event that the interference devices 172 are not to be arranged close to the FPGAs 171 in order to inject interference signals in patterns not as fine as in FIGS. 1 to 16, but to inject them more widely and for many FPGAs in the same or a similar manner, the apparatus may comprise a plurality of FPGAs 171 and control circuit boards which are arranged, for example, as per FIG. 17A, in a square around a common interference device 172, which can be configured as a column. Such a group of four FPGAs 171, or for example even a group of eight (for reasons of clarity only seven are shown), can then form an AI basic unit in conjunction with the interference device 172 and the intervening coupling device 173.

FIGS. 17B to 17D show further examples of apparatuses in plan view. In FIG. 17B, the FPGAs of an apparatus are arranged in a triangle arrangement and in FIG. 17C in a hexagonal arrangement.

FIG. 17D shows an apparatus of which the FPGAs and thus hardware-based artificial neural networks are arranged in a rectangle-chain system. The coupling medium of the coupling device 173 may be a gas or a material that readily transmits the respective interference signals to the FPGA chips. As a rule, it can be formed homogenously from the interference signal column 172 due to the breadth effect. Alternatively, it may comprise a layered or other type of composition of highly and poorly transmitting materials. Other groupings can be implemented in an analogous manner. Common to all of them is that they can be combined into more complex arrangements, systems and ensembles, as described in FIGS. 13 to 16.

FIG. 18 shows a flowchart that illustrates a method for training a system according to the preceding description, wherein firstly a method 180 for training an artificial neural network in an apparatus according to the preceding description is carried out. The apparatuses of the system can be initially trained.

In a first optional step 187 of the method 180, the hardware-based artificial neural network of an apparatus can initially be trained without the injection of interference signals. In this step, the hardware-based artificial neural network is trained to a preliminary performance value.

In a further step 181, target output data can be defined which represents the desired result of the processing of supplied training data by the hardware-based artificial neural network. This step can be performed at any time before the subsequent steps and also simultaneously or before the optional step 187.

Furthermore, in step 182, the supplied training data can be used for the training of the hardware-based artificial neural network. For this purpose, the training data is fed into the input layer of the neural network, wherein the interference device injects interference signals into at least one region of the hardware-based artificial neural network. In this process, parts of a node of the hardware-based artificial neural network, an entire node or multiple nodes may be arranged in the at least one region.

In a further step 183, the output data of the hardware-based artificial neural network is obtained. Because the network is hardware-based, the training data is processed simultaneously across all nodes of a network layer, so that the output data is available within a few ms.

Thereafter, in step 184 a deviation between the output data and the target output data is determined. If the deviation is outside a predefined tolerance range, for example, if the deviation is greater than 1%, the hardware-based artificial neural network is reconfigured. The at least one interference signal can also be optionally modified. If multiple interference signals are used, it is sufficient to modify a single interference signal, e.g. by activating an interference element of the interference device.

Steps 182 to 184 are repeated with the modified hardware-based artificial neural network and the possibly modified interference signals being fed in.

If the deviation is within the predefined tolerance range, the training of the apparatus is ended at step 185.

When all apparatuses have been trained with the method 180, an arrangement of the apparatuses can be trained in a further method 188. For this purpose, the apparatuses of the arrangement coupled to each other via the interference devices are trained in accordance with steps 182 to 186. However, this does not rule out the possibility of also training the arrangement without carrying out the method for the apparatuses beforehand.

In the training of the arrangement it is possible to proceed in a similar way to the method 180, wherein at least some interference devices can be influenced or controlled by the hardware-based artificial neural networks of other apparatuses.

When all the arrangements of a system have been trained using the method 188, the system can be trained according to the method 189. For this purpose, the apparatuses or arrangements of the system coupled to each other via the interference devices are trained in accordance with steps 182 to 186. However, this does not rule out the possibility of also training the system without carrying out the method for the arrangements or the apparatuses beforehand.

Furthermore, an ensemble can be trained in such a way that the systems are trained according to the description given above first and then the entire ensemble. However, this does not rule out the possibility of also training the ensemble without prior training of the systems, the arrangement and/or the apparatuses.

In the following, a further exemplary embodiment is described in which the artificial hardware-based neural network is not altered in its structure during training. The artificial hardware-based neural network can be implemented as a semiconductor chip, which can have side length dimensions from a fraction to several inches. On the semiconductor chip, a plurality of analog and/or digital basic electronic circuits each with x inputs and y outputs can be processed in an array arrangement, as previously the case for example with FPGA chips. With an assumed square size of a semiconductor substrate of 2 inches side length and the realization of a complete electronic module or basic circuit of electronic components on a chip area of 2 μm×2 μm, this results in a total number of connectable module fields of more than 100 million. This is a sufficiently high number to generate even highly complex artificial hardware-based neural networks. In contrast to previous approaches, however, these electronic assemblies are hard-wired and not all inputs and outputs need to be used. All basic circuits, and thus each of the millions of module fields, are connected to a supply voltage, regardless of whether they are connected to the network or not. The assemblies are not limited to being linked to the neighboring assemblies and can also be multiply linked.

The selected connections can be made entirely without circuit logic, i.e. randomly, or in a specific proportion, e.g. 40% random, 60% electronically meaningful connections, as is obtained, for example, with previous artificial hardware-based neural networks after training. On the other hand, the connections between the assemblies or electronic components can also follow an already proven network pattern which was derived from previous artificial hardware-based neural networks, separate modeling processes or training runs. This produces the advantage that the artificial hardware-based neural network can be produced in large numbers as a semiconductor chip that is always identical. In contrast to the previous FPGA chips and other artificial hardware-based neural networks, the artificial hardware-based neural network in this exemplary embodiment can no longer be trained directly, i.e. in the artificial hardware-based neural network new connections can no longer be added and removed by external wiring. The very complex switching matrix required for this is no longer required, which simplifies the semiconductor system considerably.

In this example, the respective electronic assemblies or components can instead be provided with optically addressable components, e.g. photoresistors, photodiodes and/or phototransistors during the processing of the chip and, optionally, modified in relation to the conventional switching technology so that each of the millions of module fields can be influenced via optical injections at one or more points.

However, instead of or in addition to the optically addressable components, it is possible to use components that are addressable via acoustic, capacitive, electromagnetic, quantum-mechanical, resistive, thermal and/or ionizing signals. The explanations for this example apply in the same way to each of the component addressing options explained above.

For example, by replacing some of the components usually already present in the respective electronic circuit, but not light-sensitive ones, a suitable module can be created by inserting additional light-sensitive components. The replacement does not have to comply with an electrical logic or meaningful system.

As an example, this is illustrated in FIG. 19A and FIG. 19B for an analog circuit and FIGS. 20A and 20B for a digital circuit on a discrete component diagram in each case. In principle, any circuits commonly used in electronics can be used and modified in this way. The more complex the circuits, the more possibilities arise for the controllability, which in this example is optically induced.

FIG. 19A shows an instrumentation amplifier. FIG. 19B shows exemplary modifications via photoresistors, which can either replace individual resistors or those present in groups or can be inserted additionally. The additional photoresistor branch does not represent an electrically meaningful change, but it significantly affects the signal flow of the amplifier. This is a characteristic of the modifications according to the invention in the basic circuits of the artificial hardware-based neural network.

In an analogous manner, all possible analog circuits as are commonly used in electronics are suitable for these modifications, which may also comprise, either individually or in combination, photodiodes, phototransistors and other light-sensitive components, or components which can be addressed in other ways as explained above. The appropriately modified circuits are processed in semiconductor technology in a known manner in a multilayer design, so that the above-mentioned miniaturization allows the high number of module fields, which is preferably at least in the upper million range, on the chip. Suitable optical injections can then be introduced, for example, into elements such as operational amplifiers themselves, which are also processed in semiconductor technology from transistors, resistors, etc. on a silicon chip. Assuming an average of 3 to 15 photoelements per basic circuit, this results in potential manipulation options at the local semiconductor chip level in a 2-inch chip of several billion, which represents more than enough variation potential for a neural network.

FIG. 20B shows corresponding modifications for a digital circuit using the example of a NAND gate. FIG. 20A shows the conventional circuit as implemented with discrete components using diode-transistor logic technology.

A further deviation according to the invention from the conventional semiconductor realization in the artificial hardware-based neural network is that the module fields are not permanently tied to a common supply voltage (Uₛₛ), but are each connected separately via a switching element, for example a photoresistor, a photodiode, a phototransistor or else without light sensitivity via a thyristor, field effect transistor, etc. With the switching element, the supply voltage for the corresponding electronic component of the artificial hardware-based neural network can be switched on and off as well as dimmed.

The array-like structure of the semiconductor chip for the artificial hardware-based neural network can be described as shown in FIG. 21, for example, by means of a chip 211 with side length a and b of 2 inches each, on which are located the module fields with the photo-modified circuits 212 in an arrangement of rows n and columns m. Each module circuit can have inputs and outputs that can be permanently connected to other modules, also in multiple layers, and in their entirety can form the complex structure of the artificial hardware-based neural network. For typical dimensions c and d of the module fields of 1 μm to 5 μm each, total numbers of 10 million to several 100 million electronic module fields or individual circuits according to FIGS. 19A, B and 20A, B are easily obtained. Both the processing of the individual circuits and the production of the connections between the electronic components across multiple layers can be carried out, for example, according to the prior art, as can the definition of an input and output region. The planar surface of the chip can be kept optically transparent for the injection of light.

To provide selective manipulation of the module fields of the artificial hardware-based neural network, for example, an LED array with the highest possible resolution and the same or similar dimensions as/to the artificial hardware-based neural network can be used as an interference device. The interference device can be galvanically decoupled from the artificial hardware-based neural network. Such arrays may correspond to those of the prior art and may have, for example, indium gallium nitride as a material. Furthermore, they can be limited to approx. 10 μm pixel pitch dimensions (fine pixel pitch LED technology) due to the currently comparatively low light output. However, as light-sensitive LCD chips in digital cameras prove, the size of LED elements in arrays could also technologically be reduced to pixel pitch dimensions in the sub-micrometer range (down to 50 nm), because in the application described here the high luminous output required for large screens or displays is irrelevant. This kind of miniaturization is beneficial, but not absolutely necessary. It is sufficient to allow a very local illumination of the surface of the artificial hardware-based neural network, if possible separately for each light-sensitive electronic component of the artificial hardware-based neural network. In contrast to display screens, the luminous output plays a minor role in this arrangement for artificial hardware-based neural networks so that optical near-field effects can also be used, which permit very local illumination in the sub-micrometer range.

Since such arrays usually produce small screens, light strips and the like, the LED elements can also be activated, for example, according to the prior art and arbitrary light patterns can be generated, which in terms of resolution depend only on the number of pixels and the pixel-pitch ratio. In addition to LEDs, other miniaturized light sources can also be used in array form, e.g. OLED or QDOT.

The aim of the application described here is to generate a light pattern with the highest possible resolution, usually light/dark of any wavelength being sufficient to illuminate the artificial hardware-based neural network. Wherever a light-emitting LED element is located over a photosensitive module field of the artificial hardware-based neural network, this circuit can be selectively altered in its electrical behavior, as indicated for example in FIG. 22C. For this purpose, the interference device 222 is positioned atop the artificial hardware-based neural network 221 and with a small separation, for example in the submillimeter range and below, as shown in FIG. 22A. In this example, the interference device 222 has a plurality of LED elements 224 as interference elements, wherein in FIG. 22A only an excerpt of the LED elements 224 is shown. In order to limit the light irradiation of the LED elements 224 laterally and make it even more local, a mask 411 may be arranged between the artificial hardware-based neural network 221 and the interference device 222, as shown in FIG. 22B. In order to avoid difficult adjustments in this sandwich structure, the mask 411 can also be processed directly on a transparent surface of the artificial hardware-based neural network as a thin layer, in particular in the micrometer to sub-micrometer range. Diffractive elements and/or light of different wavelengths, possibly combined with optical filters, are also applicable.

The reference signs in FIGS. 22A-C are as follows: 223—detail of electronic module fields; 224—detail of LED elements; 228 and 410—light-sensitive components in the basic circuit field 223; 411 and 412: mask with openings 227. FIG. 22B shows a cross-sectional view of one of the array fields of the interference device 222 and an electronic component field of the artificial hardware-based neural network as well as a control device 225 for providing control signals for switching elements. The control device may be designed in the same way as the interference device.

As a result of training an artificial hardware-based neural network, a complex light pattern can be generated in the interference device via the array of LED elements, which is impressed upon the artificial hardware-based neural network and codifies its task for use as artificial intelligence. By way of the large number of possible manipulations due to millions of LED pixels and many photosensitive components in the basic circuit fields of the artificial hardware-based neural network, a number of degrees of freedom can now exist comparable to that required for the training of an artificial hardware-based neural network, which can also be referred to as Artificial Intelligence, without the need to change anything in the hardware structure of the artificial hardware-based neural network. The technologically difficult breaking and linking of electrical connections between the nodes of conventional artificial hardware-based neural networks has been replaced according to the invention by the generation of an individual illumination pattern and the introduction of many light-sensitive electronic components. The generation of the illumination patterns can be performed under computer control and thus also removes the limitation in the upscaling of systems of artificial hardware-based neural networks and the training problems. At the same time, there is compatibility with digital computers. The number of degrees of freedom for manipulations can be increased by using different wavelengths of light, time-dependent signals, etc. The interference device is galvanically decoupled in the described form, which greatly simplifies the multilayer structure of the semiconductor component of the artificial hardware-based neural network.

To further increase the degrees of freedom and the possibilities for further manipulations of the semiconductor chip array of the artificial hardware-based neural network by purely electrical means, a switching array can be used as part of a control device. This allows the supply voltages of the individual basic circuit fields or electronic components of the artificial hardware-based neural network to be switched on and off or also dimmed. This can be carried out in a separate chip system and is explained in the following using the example of a second optical, galvanically isolated array. Alternatively, it can be integrated in galvanically coupled form into the semiconductor chip of the artificial hardware-based neural network.

As shown in FIG. 22A, the semiconductor chip 221 with the array of modified basic circuits 223, which are part of the artificial hardware-based neural network, can be implemented in an optically transparent form on the upper and lower sides and be placed between the interference device 222 and the control device 225, which can both consist of LED arrays 224 and 226. The arrows indicate how the arrays can be mounted on the surface of 221 from below and above. A detail as a section through the 3-component system of interference device 222, artificial hardware-based neural network 221 and control device 225 is shown schematically in FIG. 22B. The semiconductor chip of the artificial hardware-based neural network with its many layers 413, which can form the basic circuit fields 223 and can contain photosensitive elements 228, is located in the center. On the underside the chip can have an opaque thin layer 229, so that the light from the array of LEDs 226 of the control device 225 only reaches the photosensitive components 410 in the supply voltage controller of all the basic circuits, but cannot travel further to the photosensitive components 228 in the basic circuit layers and vice versa for the upper light layer of the interference device. A layer with the function of a mask 412 can also be processed or inserted on the underside in the same way as the layer 411, as for the upper LED array. Depending on the trained pattern, the LEDs 224 and 226, here only three being shown hatched, can irradiate the light-sensitive components 228 of the basic circuit fields through the mask layers and irradiate the e.g. light-sensitive dimming transistors 410 from below for generating the individual supply voltages. By manipulating the supply voltage of each of the millions of basic circuit fields from below via the control device, the circuits of the array of the artificial hardware-based neural network can be switched on, decoupled or dimmed individually and independently of each other.

The control device 225 can also be used for training the artificial hardware-based neural network and can form a second two-dimensional light pattern. This allows the number of possible changes to the overall device to be increased considerably.

The connection, interruption or dimming of the supply voltage can be performed via electrical switching elements, in particular phototransistors, photoresistors, photodiodes, thyristors, field effect transistors, Zener diodes, etc., and also in miniaturized form in classical semiconductor processing. An example circuit showing how the supply voltage Uss to the individual basic circuits can be switched and dimmed via phototransistors T1 and T2 is shown in FIG. 22C for two basic circuit fields 223 BS1 and BS2. Only when light falls on the transistors T1 and/or T2 is the supply voltage applied to the respective basic circuit field BS1 and/or BS2 of the artificial hardware-based neural network.

However, the design of the control device for manipulating the supply voltage via a second photoarray is also particularly advantageous, because this is also coupled to the artificial hardware-based neural network in an electrically isolated manner. In particular, the dimming corresponds to a shift in the weights of the individual basic circuit components of the overall network. Viewed in this way, the component fields of the artificial hardware-based neural network can represent the nodes of the artificial software-based neural networks in an analogous manner. Dimming can affect their weight, their switching on or off, the addition or removal of nodes and the manipulation of the electrical behavior of the circuit via the light injection can represent in analogous manner the linking and breaking of connections in artificial software-based neural networks, no longer possible for the artificial hardware-based neural network of this example. The example illustrates the attainably high number of changes in highly scaled, complex networks, now easily controlled electronically and with the aid of computers, such as those required for artificial intelligence systems, thus eliminating the previous disadvantages of artificial hardware-based neural networks.

An overview diagram with a detail of the apparatus overall system is shown in FIG. 23. This is a compact chip-based sandwich structure comprising the artificial hardware-based neural network 221 with the basic circuit fields 223, shown hatched, the interference device 222 with the LED array 224, the mask 235, the control device 226, and a switching element array 237 for controlling the supply voltage Uss of the individual basic circuit fields 223 of the artificial hardware-based neural network.

The training of the system can be carried out by making changes using known learning algorithms only in the interference device and the control device, but not as previously in the artificial hardware-based neural network. For this purpose, LED activations can be changed on a random basis, new LED activations can be introduced into the pattern, and basic circuit fields can be switched off and new ones can be switched on or dimmed according to a learning algorithm. With a sufficient number of iteration steps, the artificial hardware-based neural network can learn by the fact that its properties are determined by the injection of the light pattern forming in the interference device in combination with the second light pattern, which can also develop in the control device as an array pattern and can affect the photosensitive components of the artificial hardware-based neural network. Due to the enormous number, in particular in the multi-digit billion range of possible settings for such a combination of components, the inventive system corresponds in its degrees of freedom or learning to the physical detachment and coupling of conventional hardware-based neural networks, which are to be avoided, but now without the previous technological disadvantages.

The method for training can be variable and work on the principle of making a change only if the result does not serve the training goal. For example, the increment over the number and type of changes per learning cycle can be varied. For example, a method known from the prior art can be used for the training procedure.

As explained in the example according to FIGS. 19A to 22, the training of the system can lead to an optical, two-dimensional array pattern with a resolution of more than 10⁷ to 10⁹ or more pixels and a switching pattern of more than 10⁸ switching states, also in the form of a two-dimensional array. These figures reflect the enormous number of ways of influencing the artificial hardware-based neural network. The crucial advantage is that both arrays are independent of each other and the patterns of the arrays are formed individually by the training in order then, at the end of the training, to be completely defined, in particular in their x-y coordinates, and stored as activation patterns of the interference device and the control device.

Assuming as a training example an image recognition problem, for example the discrimination between wolves and dogs, the training then leads to two individual array patterns, one pattern in the interference device and another pattern in the control device, in which the system correctly classifies with a high hit rate. If the training is carried out once again with other images, other patterns are produced which also lead to a high hit rate. Therefore, the patterns of the arrays can be referred to as individual patterns. These patterns can be stored in a separate set of electronics or a connected computer, for example, as a digital image. At a later time, they can be retrieved and are able to be regenerated by the interference device and the control device and thus repeated without the artificial hardware-based neural network being altered in its hardware structure.

This is a decisive advantage because the entire system can be retrained, e.g. to distinguish between beech trees and oak trees. Two other array patterns will be obtained that will also be stored for later retrieval. This can be repeated with any number of training goals. A library of array-pattern combinations of the interference device and the control device is created, each as a pair, which, when loaded from the memory and generated on the interference device and the control device, can allow precisely the use of the artificial hardware-based neural network with respect to the distinctions achieved in training. That is, with one pattern pair, the artificial hardware-based neural network can detect and distinguish between wolves and dogs, and with another pair, beech and oak trees, etc.

The particular advantage of the apparatus according to the invention over artificial software-based neural networks is that after completion of the training the artificial hardware-based neural network of the apparatus will come to a result very quickly in use, because no expansive computer program needs to be run. The speed advantage arises because when input signals are applied, a large number of pulses passes through the chip of the electronic network with the switching speed of the electronic components, wherein the switching frequencies can currently typically be in the upper MHz to GHZ range. Since a large number of pulses are coupled through the electronic network in parallel, forwards and backwards, but also run with a delay and sometimes in sequence, the result is available after one chip pass, thus very quickly, i.e. in the millisecond, microsecond range or even shorter.

The step toward a more broadly usable, potentially universal AI is now made possible by the serial retrievability, for example, pattern pair by pattern pair in sequence, of any number of pattern pairs for all possible previously trained discrimination tasks. A certain level of universal intelligence has already been achieved if the system has been trained in such a way that, for example, with an image at the input for the dog-wolf discrimination it has only three possible responses:
1. It's a wolf!
2. It's a dog!
3. It's neither of them!

The use of the apparatus as a universal artificial intelligence can then take place as follows: a user applies an image to the inputs of the apparatus, e.g. of a landscape, with trees, houses, animals, cars etc. and generates a pair of patterns in the interference device and the control device that has already been obtained from the training, wherein the same input image can be used every time. The responses obtained from the apparatus are stored for each pattern pair. For example, if one apparatus run takes 1 ms, then in 1 s one obtains a thousand responses of the type: it is a dog/it is a beech/it is a house/it is not a fish/it is not a mountain, etc. Taking the responses that confirm something, one then already has a description of what is shown in the picture, a first interpretation. This can be a step towards a universal intelligence.

The format of the apparatus according to the example of FIGS. 19A to 23 can be extended for multiple to universal use via a periphery, as illustrated in the example of FIG. 24. 241 designates the apparatus with the interference device 222 as an optical array and the control device 225 as a supply voltage switching array, with the artificial hardware-based neural network 221 interposed. 242 stands for an input module, via which, for example, images in standardized pixel representation can be entered. 243 represents the activation electronics for the LED array of the interference device and 244 a memory for the array patterns, which records the activation data of the individual training results and can generate it in the interference device as required via the activation electronics 243. Similarly, 245 stands for an activation electronics of the switching device and 246 for a memory for the switching array pattern. The memories 244 and 246 can form a common memory. The result is processed further, listed, displayed on a screen or output acoustically in 248.

Even if a serial query over each of the pattern pairs to be fed in takes time, this is more than compensated for by another advantage. At present, increasingly powerful artificial hardware- and software-based neural networks require ever more extensive networks with a greater than linear increase in complexity, which, among other reasons, leads to the limitations already described. The solution presented here also reduces this problem of an unmanageable increase in complexity and expenditure, because the same artificial hardware-based neural network, unchanged in its hardware structure, is used to answer the most diverse questions. The problem of the technologically difficult network expansion is shifted to the creation of a large number of corresponding pattern pairs, which is much simpler in terms of data technology and informatics than the expansion of hardware or software networks.

The following is an estimation of the switching speeds/cycle rates of an apparatus according to FIG. 24.

LEDs have switching times of less than 1 μs with peak values between 1 ns and 10 ns. The response latency of the LED in an array is therefore not time-limiting in the present case, but rather the activation of the LED array until the formation of the complete light pattern. In this example, the data transmission to the arrays would take place via electrical conductors. For these, the achievable transmission rates are currently between 1 Gbit/s and 40 Gbit/s, e.g. mass storage interface SATA Express, serial interfaces such as SAS-1 and -3 or Serial ATA, Thunderbolt interfaces, USB 4. Assuming an LED array of 10⁷ pixels, switching rates obtained for the pixel patterns of the overall array are in the ms range and below, wherein for large LED screens the refresh rates of the images are currently 360 fps, for small LED displays 1920 and 3840 fps. By using parallelization, this can be reduced by a factor of 10 again, so that approx. 1000 to 30 000 patterns/s can expect to be generated. The great advantage of the apparatus is its rapid execution, which, as already mentioned, is determined by the switching times of the electronic components and the length of the dominant connections in the network. Assuming switching frequencies in the upper MHz up to GHz, e.g. CMOS technology, then here also the working speed or the cycle rate of the usability of the artificial hardware-based neural network is in the ms range and below. This means that the artificial hardware-based neural network can provide more than 1000 decisions/s via pattern changes. This rate can also be increased by parallelization of multiple apparatuses. This results in potential cycle rates for various queries of the apparatus from 1000 to 10 000/s.

In order to increase the security of such AI systems, special pattern pairs can be generated by the manufacturer or operator, which when imported into the arrays produce a known, specific response reaction from which it can be detected that the artificial hardware-based neural network has not been altered, replaced or otherwise manipulated, in particular in the form of a challenge-response procedure and as a test task. This also fulfills the task of enabling authentication via one or more test patterns.

Updates can be realized in the AI system by importing further or improved pattern pairs into the corresponding memory (see FIG. 24), since the semiconductor chip of the artificial hardware-based neural network can remain unchanged under these extensions.

In FIG. 25, an apparatus-system comprising multiple layers is shown. For example, the image of an animal 252 in pixel format is fed into the input layer 251. The layers 253 and 254 can be chips with different dimensions according to FIG. 22, which can be followed by further ones (represented by dots). For example, layer 253 is more complex than layer 254 and may have more than one million switching modules. Layer 254 can be less complex than layer 253, e.g., have fewer than 10 000 switching modules. Each layer again includes two LED arrays 256, 257 and 258, 259, which can then also have different dimensions, for example in the number of LED elements. The output layer 255 can present the result. In this example, this is the statement “It is a lion” in text form.

FIG. 26 illustrates the serial querying of an apparatus which was trained with n different LED array pattern pairs to recognize animals, faces, landscapes, etc. This can be carried out successively in a chronologically ordered sequence, here t₁, t₂, t₃ . . . tₙ, or chronologically unordered. The apparatus shown would perform a classification into rough categories, e.g., if a giraffe image is input, give the classification “Is an animal”. It could be followed by another apparatus of this kind, which then performs a further and finer classification, for example in the case of an animal image, recognizing what kind of animal it is (“giraffe”). A subsequent apparatus could then have been trained on giraffes and recognize that the image is the head of a certain giraffe species (e.g. “Africa, Serengeti, adult, female”) etc.

Such hierarchically cascaded apparatuses can be used to develop more complex arrangements and systems with universal intelligence.

FIG. 27 shows the overall structure once again, illustrating its parts more clearly, while also summarizing the options for the effects of light on the circuit blocks of the central network electronics.

The luminous flux of each pixel over the working period of the central network (i.e., during a processing run after an image is input) can be either a) constant, b) a function of time (alternating or discontinuously periodic) and/or c) stochastic (superimposed noise).

The example described above does not in any way limit the invention. Rather, the invention can be modified in a variety of ways. All the features of the invention described above may be essential to the invention, either alone or in combination with each other.

1. An apparatus for operating a hardware-based artificial neural network, comprising at least one hardware-based artificial neural network having a plurality of electrically interconnected network nodes, each network node comprising at least one electronic component, characterized in that the hardware-based artificial neural network has an invariant hardware structure, the apparatus comprising at least one interference device for injecting at least one interference signal into at least one region of the hardware-based artificial neural network and at least one coupling device, the coupling device being positioned between the interference device and the hardware-based artificial neural network and being designed to transmit the at least one interference signal from the interference device to the entirety of the at least one region, and/or the apparatus having at least one switching element, which can be actuated separately by means of at least one control signal, for dimming and/or switching a supply voltage for the at least one electronic component on and off.

2. The apparatus of claim 1, wherein the hardware-based artificial neural network in the at least one region has at least one component, which is designed to reduce the signal-to-noise ratio upon receipt of the at least one interference signal.

3. The apparatus of claim 1, wherein the interference device has a plurality of individually actuatable interference elements for injecting an interference signal into the hardware-based neural network.

4. The apparatus of claim 3, wherein the plurality of the interference elements are arranged to be distributed over a layer, wherein the coupling means comprises a medium having a plurality of coupling elements for transmitting the at least one interference signal into the at least one region, the coupling elements being distributed in the layer like the interference elements.

5. The apparatus of claim 1, wherein the at least one region has an extent corresponding to the extent of the hardware-based artificial neural network or is designed to be smaller than the extent of the hardware-based artificial neural network.

6. The apparatus of claim 1, wherein the apparatus has at least one semiconductor chip, wherein the semiconductor chip comprises the hardware-based artificial neural network.

7. The apparatus of claim 1, wherein the apparatus comprises a shielding device for shielding external interference signals which are of the same type as the at least one interference signal, wherein the shielding device surrounds the hardware-based artificial neural network, the coupling device and the interference device.

8. The apparatus of claim 1, wherein the apparatus further comprises at least one memory for storing the at least one interference signal used by the at least one interference device and/or the at least one control signal, at least one control unit for controlling the at least one interference device and/or the at least one switching element, and/or at least one output unit for outputting a further processed output signal of the hardware-based artificial neural network.

9. The apparatus of claim 1, wherein the interference device is designed as a control device for providing at least one control signal for at least one switching element.

10. A method for training an artificial neural network in an apparatus of claim 1, wherein the method comprises at least steps of:
defining target output data during the processing of supplied training data;
feeding the training data into the hardware-based artificial neural network and injecting at least one interference signal into the at least one region of the hardware-based artificial neural network by means of the at least one interference device;
obtaining output data from the hardware-based artificial neural network;
determining whether at least one deviation exists between the output data and the target output data, said deviation being located outside a predetermined tolerance range;
if the deviation is within the tolerance range:
terminating the method; and
if the deviation is located outside the predetermined tolerance range:
modifying the at least one interference signal and/or modifying the at least one control signal, and
repeating the steps of feeding, obtaining, and determining and terminating or modifying.

11. The method of claim 10, wherein a signal-to-noise ratio of not greater than 15 dB, optionally not greater than 10 dB, further optionally not greater than 0 dB, is generated in the at least one region by means of the injected interference signal.

12. The method of claim 10, wherein the hardware-based artificial neural network remains unchanged in its structure.

13. The method of claim 10, wherein the last obtained interference signal and/or control signal is stored, wherein after the step of terminating the method, the method is carried out at least once again using the same apparatus with modified target output data and training data.

14. The method of claim 10, wherein the interference signals and/or control signals are test signals, wherein, when the test signals are used for feeding in predefined test data, predefined output data are provided only if no part of the hardware-based artificial neural network is damaged, has been replaced and/or been manipulated.

15. A method for processing two different signal sets comprising a step of operating the apparatus of claim 1, wherein the step of operating, the apparatus is operated sequentially with at least two different signal sets for different tasks, wherein each signal set comprises at least one interference signal and/or control signal.

16. The apparatus of claim 2, wherein the interference device generates an optical, acoustic, capacitive, electromagnetic, quantum-mechanical, resistive, thermal and/or ionizing interference signal and/or the switching element is designed to receive an optical, acoustic, capacitive, electromagnetic, quantum-mechanical, resistive, thermal and/or ionizing control signal.

17. The apparatus of claim 3 wherein the interference elements inject an interference signal into different regions of the hardware-based artificial neural network.

18. The apparatus of claim 4, wherein the plurality of the interference elements are in the form of an array.

19. The method of claim 13 wherein the last obtained interference signal and/or control signal is stored together with a marker value for identifying the target output data used.
